(19) United States
(12) Patent Application Publication
(10) Pub. No.: US 2013/0177768 A1
(43) Pub. Date: Jul. 11, 2013

(54) METHOD FOR COATING METALLIC SURFACES WITH A COATING AGENT CONTAINING A POLYMER, THE COATING AGENT, AND USE THEREOF

(71) Applicants: Mike Krüger, Berlin (DE); Petra Grünberg, Frankfurt am Main (DE); Mark Andre Schneider, Friedrichsdorf-Burgholzhausen (DE); Heribert Domes, Weilmuster (DE)

(72) Inventors: Mike Krüger, Berlin (DE); Petra Grünberg, Frankfurt am Main (DE); Mark Andre Schneider, Friedrichsdorf-Burgholzhausen (DE); Heribert Domes, Weilmuster (DE)

(21) Appl. No.: 13/821,788

(22) PCT Filed: Sep. 8, 2011
(86) PCT No.: PCT/EP2011/065506

§ 371 Date: Mar. 8, 2013

(30) Foreign Application Priority Data
Sep. 10, 2010 (DE) 10 2010 040 548.5

(51) Int. Cl. C09D 175/04

(52) U.S. Cl. CPC C09D 175/04
USPC 428/412; 524/413; 427/435; 428/425.8

(57) ABSTRACT

The invention relates to a method for coating metallic surfaces with an aqueous composition as a solution or as a dispersion, wherein the composition contains a) at least one phosphate, b) at least 0.1 g/L of at least one titanium and/or zirconium compound, c) at least one complexing agent, d) cations of aluminum, chromium(III), and/or zinc and/or at least one compound containing aluminum, chromium(III), and/or zinc, and e) 1 to 500 g/L of at least one acid-tolerant cationic or nonionic organic polymer/copolymer, relative to the content of the solids and active substances in these additives.

The invention relates to a method for coating metallic surfaces with an aqueous composition which differs from phosphating solutions, the composition containing acid-tolerant cationic and/or nonionic organic polymer/copolymer, and the use of the metallic substrates coated using the method according to the invention.

DE 102008000600 A1 describes a method for coating metallic surfaces with a passivating agent, without specifically stating the content of certain organic polymers/copolymers, the passivating agent, and use thereof. However, the examples do not state any contents of organic polymer/copolymer.

In the following description, the terms “passivating agent,” “composition,” and “passivating method” are retained for the aqueous compositions and the method of the present patent application, even though in many cases the aqueous compositions and method are used not for passivation, but, rather, for purposes of an organic coating, such as an organic coating which may be formed as a so-called “dry lube” if necessary.

Phosphate coatings are widely used as corrosion protection layers, as a forming aid, and as an adherent surface for lacquers and other coatings. In particular when they are used as a protective layer for a limited period of time, especially storage, and then lacquered, for example, they are referred to as a “pretreatment layer” before lacquering. However, if no lacquer layer or other type of organic coating is applied to the phosphate coating, this is referred to as “treatment” or “passivation” instead of “pretreatment.” These coatings are also referred to as conversion layers when at least one cation of the metallic surface, i.e., the surface of the metal part, is leached out and used for the layered structure.

In the coating methods without subsequent rinsing, in particular after a conversion coating, the so-called drying processes (“no-rinse processes”) have considerable importance, especially for the rapid coating of continuously conveyed strips made of at least one metallic material. These strips may be sheets having small or very large widths. A phosphate coating is applied to these strips, usually directly after galvanizing, but optionally also after suitable cleaning or degreasing and after rinsing with water or an aqueous medium, and optionally after activating the metallic surface, by wetting with a phosphating solution, and the strips are dried. The strips could be damaged by rinsing after the phosphate coating has dried, in particular if the phosphate coating is noncrystalline or only partially crystalline.

In the past, these problems have been addressed on a commercial scale by adding nickel to the phosphating solution, so that the phosphating solution had a nickel content in the range of 0.5 to 1.5 g/L. For zinc-manganese-nickel phosphating, the zinc content was usually selected to be in the range of 0.6 to 3.5 g/L, and the manganese content, in the range of 0.4 to 2.5 g/L.

However, the high-quality phosphating solutions and phosphate layers have a significant zinc, manganese, and nickel content. Nickel in particular should be avoided due to its toxicity and harmful effects. In addition, the unavoidable heavy metal content has an adverse impact in wastewater, phosphate sludge, and grinding dust. However, no process for treating strips is available that ensures high bare corrosion protection (corrosion protection in the absence of lacquer/primer layers), in particular for zinc-rich metallic surfaces.

Despite the comparatively high phosphate content of the unmodified inorganic passivating agent of DE 102008000600 A1 the compositions are not phosphating solutions, and the coating process is not phosphating, since a phosphating solution:

1. For high-quality phosphate layers, for example for zinc- and/or manganese-rich phosphating processes, prior activation, for example based on titanium phosphate particles or zinc phosphate particles, is necessary to allow formation of a high-quality phosphate layer;
2. As a rule, only a pH range from 2 to 3.5 may be used in zinc-containing phosphating operations:
3. An overall content of titanium and/or zirconium compounds greater than 0.05 g/L or greater than 0.1 g/L is generally not tolerable without adverse effects, since titanium and zirconium compounds for phosphating are known to be bath contaminants;
4. In practice, there is never a significant content of silanes/silanols/siloxanes/polysiloxanes;
5. A low content of a complexing agent is seldom present, since complexing agents are sometimes regarded as bath contaminants;
6. An overall content of cations in the range of 3.5 to 9.5 g/L, and of phosphorus-containing compounds in the range of 5 to 20 g/L, calculated as PO₄, is generally present in bath solutions;
7. An elevated content of alkali and ammonium compounds is often present, the pH generally remaining in the range of 2.0 to 3.5, even for comparatively high contents of ammonium compounds;
8. For a content of at least one complex fluoride, normally only compounds based on boron and/or silicon complex fluoride are present;
9. For phosphating of parts using a zinc- and/or manganese-rich phosphating solution, crystalline layers of typical crystal forms are usually formed, at least for the treatment of single parts, for example by dipping and/or spraying; and
10. For bare corrosion protection, the crystalline zinc phosphated surfaces withstand a salt spray test on phosphated, unlacquered surfaces typically only up to two hours without rust formation, due to the pores and lack of cohesiveness, while the coatings according to the invention usually withstand a salt spray test for at least two days without additional lacquer treatment, without the coatings according to the invention being thicker than the comparable phosphated coatings.

When, in very rare cases, a titanium and/or zirconium compound is used in a phosphating solution for a phosphating process, the overall content of these compounds is typically less than 0.2 g/L. This is because it is known that higher contents of these compounds usually result in defective coatings, in particular on aluminum-rich surfaces. It is very uncommon to add a complexing agent and/or an organic polymer/copolymer to a phosphating solution. When, in very rare cases, a silane is used in a phosphating solution for a phosphating process, the content is very low. However, a combination of these stated additives is never used in phosphating.

It has consistently been found that the behavior of the unmodified aqueous inorganic compositions (i.e., aqueous compositions which contain no organic polymers and/or copolymers and which remain stable for weeks) of DE 102008000600 A1 and the properties of the coatings thereof are so different from phosphating solutions and the phosphate layers thereof that the aqueous compositions according to the invention and their coating methods cannot be referred to as phosphating. Nevertheless, the method according to the invention may be a conversion coating method of the first type.

Patent applications DE 102008000600.9 and PCT/EP2009/052767 concerning chemically similar passivating agents and passivating methods, as well as the corresponding foreign applications, are hereby explicitly incorporated by reference, in particular with regard to the aqueous compositions, the additions to the aqueous compositions, the coating steps, the bath characteristics, the layer formation, the layer properties, and the determined effects, in particular for the exemplary embodiments and comparative examples. Similarly, the patent applications on which priority is based are explicitly incorporated by reference into the subsequent applications.

However, for passivating agents without a content of high-quality organic polymers/copolymers, the dry film that is formed frequently does not have sufficient moisture resistance after application and drying. In particular, the resistance to moisture immediately after drying is not adequate for a large number of uses of the treated substrate surfaces.

This problem may be solved by the selection and addition of a suitable polymer system. In addition, in this manner the corrosion resistance of the treated substrate surfaces may be greatly increased, the further processing into formed parts may be improved without additional lubricants such as greases and oils, and the overcoatability using various coating systems may be greatly improved.

It has been found that almost all of the organic polymers and copolymers which may be mixed into the passivating agent of DE 102008000600 A1 result in precipitation, in particular of polymer particles, so that the modified passivating agent can no longer be used. This is because the vast majority of the polymers and copolymers currently in common use are not stable in strongly acidic dispersions, emulsions, and/or solutions. Such precipitation results in inhomogeneous dry films which are not sufficiently filmable or sufficiently filmed. The properties of the films are therefore different, and not as satisfactory, as films with proper filming characteristics. In addition, the films are therefore often no longer transparent, although for many applications transparent films are necessary. It has been shown that all tested types of unmodified anionic organic polymers/copolymers are unstable in acidic medium, and therefore are not usable according to the invention. In addition, many of the cationic organic polymers/copolymers have proven to be unstable in acidic medium.

Surprisingly, it has now been found that a stable composition which is modified according to the invention allows the surface appearance of the substrate to remain discernible with practically no alteration. Thus, for example, the grain structure may be easily visible through the coating according to the invention.

It has also been found that organic polymers and copolymers which are mixed into the passivating agent of DE 102008000600 A1 and which do not result in precipitation significantly improve the properties of the coating thus formed, compared to the properties of the organic polymers and the copolymer-free coating. Furthermore, it has been found that individual selected organic polymers and copolymers improve the properties and the property spectrum so greatly that the fields of application of the substrates thus coated are significantly expanded.

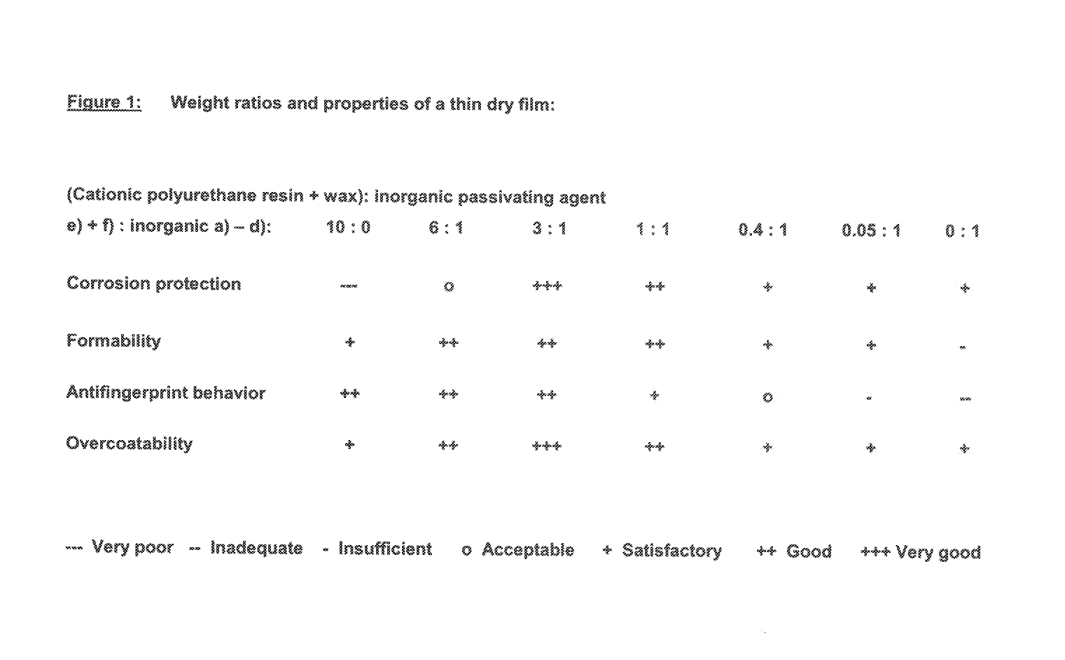

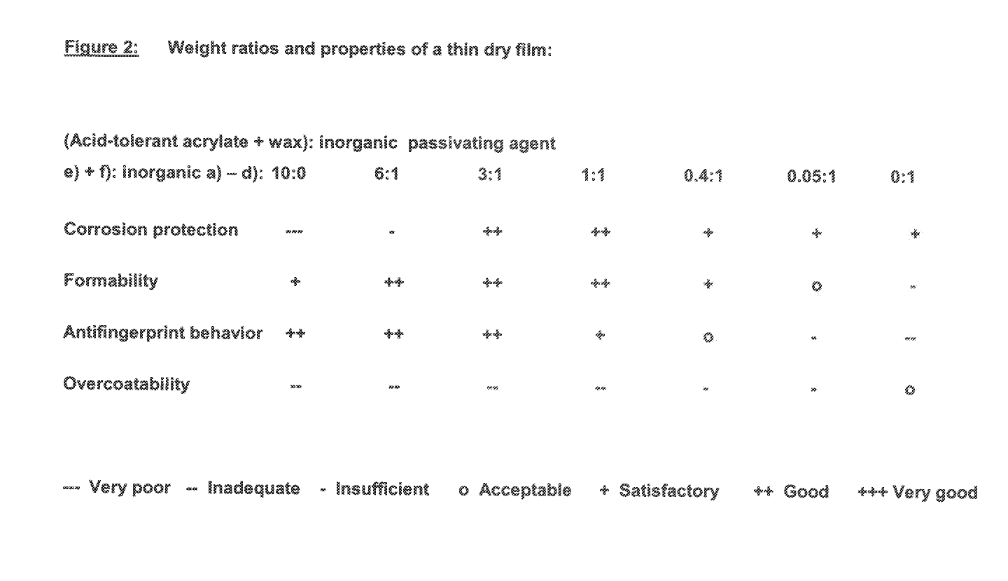

Surprisingly, it has been found that a comparatively small addition of a cationic polyurethane-rich dispersion, having a content of polycarbonate and/or an acid-tolerant dispersion based on acrylate and/or styrene which is/are present in stable form in the aqueous composition, results in a much better, different property spectrum than an unmodified passivating agent only on the basis of components a) through d), as schematically shown in FIGS. 1 and 2. However, in these figures it is not the element and compound contents that are selectively related to one another, but, rather, the ratios of inorganic passivating agent to polymers/copolymers together with their additives such as wax, for example. However, the trends indicated in the figures are a function of the specific composition and the layer thickness.

By adding a cationic polyurethane dispersion, particularly high-quality results are shown, compared to an unmodified passivating agent based only on components a) through d), in the salt spray test according to DIN EN ISO 9227, in the condensation water constant humidity test according to DIN EN ISO 6270-2 CH, in the antifingerprint properties, which are tested by immersing the treated substrate surfaces in a synthetic hand perspiration solution with appropriate evaluation by colorimetry, compared to an untreated sample, in the overcoatability, in the sliding behavior, in the wet stack test (one of the corrosion tests), and in the resistance to cleaning agents, coolants, ethanol, and deionized water.

Within the meaning of the present patent application, “passivation” is understood to mean the coating of the substrate surface with specialized inorganic and/or organic compositions, which may be applied in dry films in quantities that are often less than 1 g/m², which in particular prevent the oxidation of the substrate surface. Frequently, but not always, no subsequent organic coating for permanent anti-corrosion protection is applied, since the corrosion resistance of the passivation coating in many cases is only temporary in nature, and is sufficient for storage, transport, or further processing of the component coated with the passivating agent. However, in some cases the passivation does not rule out subsequent application of at least one organic coating such as a primer, for example, or even a lacquer system and/or an adhesive.

The object, therefore, is to propose a coating method by means of which the corrosion protection layer produced using an aqueous composition, in particular also without subsequent coating with a lacquer/primer, has good corrosion protection (bare corrosion protection), in particular on a metallic strip. It is the aim for a coil (strip coil) to typically be processable by the steel manufacturer during subsequent processing operations without rust attack. In addition, for some embodiments good formability and/or also good alkali resistance during mildly alkaline cleaning and/or during forming using alkaline and/or acidic cooling lubricants is/are advantageous. Optionally, a further aim is for the coating, also preferably after the forming, to have good corrosion protection and preferably also good lacquer adhesion. A further aim is for the layer to have so-called antifingerprint properties.

The object is achieved by a method for coating metallic surfaces, using an aqueous composition as solution or as dispersion, in which the composition contains
a) at least 1 g/L, phosphate, calculated as PO₄,
b) at least 0.1 g/L of at least one titanium and/or zirconium compound, calculated as Ti metal,
c) at least 0.1 g/L of at least one complexing agent,
d) at least 0.5 g/L of cations of aluminum, chromium(III), and/or zinc, and/or at least one compound containing aluminum, chromium(III), and/or zinc, and
e) 1 to 500 g/L of at least one acid-tolerant cationic or nonionic organic polymer/copolymer, relative to the content of solids and active substances in the additives to organic polymer/copolymer.

Cationic and nonionic organic polymers/copolymers are inherently acid-tolerant. Anionic polymers/copolymers may be modified to become acid-tolerant, for example by adding the salt of a strong acid. The acid-tolerant cationic or nonionic organic polymer/copolymer may be present as a single additive or as a mixture of single additives, or also present in the (overall) mixture e) and/or in the aqueous composition, in each case as a dispersion, solution, or colloidal solution, emulsion, and/or dispersion. The at least one acid-tolerant cationic or nonionic organic polymer/copolymer is preferably stable in the aqueous composition in the acidic and/or neutral pH range for at least five days. All organic polymers/copolymers are advantageously stable in the strongly acidic pH range, or optionally also in the weakly acidic and/or neutral pH range, in particular at a pH in the range of 1 to 6, 2 to 5, or 3 to 4. Each additive may be cationic, nonionic, or acid-tolerant anionic.

In this regard, a wet film of the aqueous composition may preferably be applied to metallic strips or sheets and dried.

Within the meaning of the present patent application, “active substances” refer to the content of substances, including solvents and ions, which take part in chemical reactions in the aqueous composition, and in chemical reactions for forming the dried and optionally also partially or completely cured coating.

A single additive for e), a mixture of single additives for e), and/or the (overall) mixture e) may have a) a minimum film formation temperature MFT preferably in the range of −20 to +100° C., in the range of 0 to +80° C., or in the range of +20 to +60° C., or the film thus formed may have b) a transformation temperature T_{g} preferably in the range of −10 to +120° C., in the range of +10 to +100° C., or in the range of +30 to +80° C., and/or c) a König pendulum hardness preferably in the range of 10 to 140 s, in the range of 30 to 120 s, or in the range of 50 to 100 s. The organic polymer/copolymer e) preferably has a minimum film formation temperature MFT in the range of −20 to +100° C., or the resulting film preferably has a transformation temperature T_{g} in the range of −10 to +120° C. and/or a König pendulum hardness in the range of 10 to 140 s.

Within the meaning of the present patent application, the terms additive or “add” mean that such a substance or such a substance mixture is intentionally added at least once.

The content of the at least one acid-tolerant cationic or nonionic organic polymer/copolymer e) in the aqueous composition, relative to the content of the solids and active substances in these additives, is preferably in the range of 8 to 400 g/L, 15 to 320 g/L, 25 to 280 g/L, 40 to 240 g/L, 60 to 200 g/L, 80 to 180 g/L, 100 to 160 g/L, or 120 to 140 g/L.

The organic polymer/copolymer e) particularly preferably contains a cationic polyurethane resin and/or a modified anionic, and therefore acid-tolerant, acrylate. The aqueous composition according to the invention advantageously contains, in addition to at least one stable cationic polyurethane resin, at least one acid-tolerant cationic or nonionic organic polymer/copolymer which is stable in the composition. The aqueous composition content of organic polymer/copolymer based on and/or having a content of poly(meth)acrylate, polyacrylamide, polycarbonate, polyepoxide, polyester, polyether, polyethylene, polystyrene, polyurethane, polyvinyl, polyvinylpyrrolidone, and/or modification(s) thereof, in particular is in the range of 1 to 500 g/L, 8 to 400 g/L, 15 to 320 g/L, 25 to 280 g/L, 40 to 240 g/L, 60 to 200 g/L, 80 to 180 g/L, 100 to 160 g/L, or 120 to 140 g/L, relative to the content of solids and active substances.

The films produced according to the invention are usually transparent, dry, or at least dried and oil-free inorganic-organic coatings having a layer thickness preferably in the range of 0.1 to 20 μm, 1 to 10 μm, or rarely, 0.1 to 50 μm. The films have excellent corrosion protection, in particular during transport, storage, and further treatment. They usually form a dry film having sliding properties, by means of which the substrate which is treated according to the invention may be processed and formed, for example, into formed components without subsequent coating with additional lubricants. The films typically have good weathering resistance, and are resistant to mildly alkaline cleaning processes. The films may be used as pretreatment before further lacquering or coating with organic compositions, such as an adhesive. When drying is carried out at temperatures in the range of 60 to 120° C. peak metal temperature (PMT), for example, a separate heat treatment for curing may be optionally be dispensed with for the low-temperature curing resins which are based, for example, on a cationic polyurethane resin and used according to the invention. In particular, the resistance of the dried film to various chemicals, for example alcohols, ketones, and acidically or alkalinically reacting media may be improved by adding hardeners, crosslinkers, polymerization initiators, etc., such as those based on aziridine, melamine formaldehyde resin, and blocked isocyanate, for example. However, in most cases the addition of melamine formaldehyde resin and/or blocked isocyanate requires drying and/or additional heating at a PMT higher than 120° C.

The compositions according to the invention represent an organic-inorganic hybrid system. At the same time, they have the properties of an acidic passivating agent and a primer.

In principle, the weight ratio of the inorganic passivating agent based on a) through d) to the organic polymer components e) may be varied over a wide range:

Weight-based ratios [a) through d)]:[e) f)] may preferably be set in the range of 20:1 to 1:30, in particular in the range of 10:1 to 1:20, particularly preferably in the range of 6:1 to 1:10 or 4:1 to 1:8, and very particularly preferably in the range of 2:1 to 1:6, 1.5:1 to 1:4, or 1:1 to 1:3, most preferably approximately 1:2; for example, in particular for the aqueous compositions and for the dry films produced therefrom.

The aqueous composition according to the invention preferably has a weight ratio of organic polymers/copolymers e) to the inorganic passivating agent based on a) through d) in the range of 8:1 to 0.2:1, or 6:1 to 08:1. Most preferred for the aqueous compositions and for the dry films produced therefrom is a weight ratio of the acid-tolerant cationic and/or nonionic polymers/copoiymers e) to the inorganic passivating agent based on a) through d) in the range of 5:1 to 0.3:1, particularly preferably in the range of 3.5:1 to 0.8:1, or 2.5:1 to 1.2:1. The organic polymers/copolymers e) are preferably copolymers.

Hydrophilic cationic groups are preferably incorporated into the skeleton and/or into side chains of the cationic polyurethane resin via at least one amine, in particular via at least one alkanolamine such as an N-alkyldialkanolamine, for example. Quaternary ammonium groups are preferably incorporated into the main chain of the cationic polyurethane resin. These groups may optionally have acid groups as anionic counterions, and/or quaternization agent groups, which form, for example, when acetic acid and/or phosphoric acid, for example, is/are used as acid, and/or dibutyl sulfate and/or benzyl chloride, for example, is/are used as quaternization agent. When acid and/or quaternization agent is/are added to the aqueous composition containing cationic polyurethane resin, for exam*, anionic counterions are preferably incorporated into the quaternary ammonium groups, for example in the main chain of the cationic polyurethane resin. Structural units having at least one silicon-containing group and/or at least one epoxy group are preferably incorporated into the cationic polyurethane resin. The cationic polyurethane resin preferably contains additives, for example at least one preservative, at least one emulsifier, at least one metal salt such as a magnesium salt, and/or at least one organic solvent, for example at least one solvent based on pyrrolidone, for example polyvinylpyrrolidone and/or methylpyrrolidone. The compatibility of the cationic polyurethane resin, for example, with the unmodified inorganic passivating agent may possibly be due to the presence of amino groups in the main chain on the one hand, and to the presence of counterions such as PO₄³⁻ on the other hand.

The selection of the particular organic (co)polymer components also depends on the properties of the desired coating. If a certain water solubility of the produced coating is adequate, nonionic organic (co)polymers may be sufficient for e). If particularly high-quality properties are desired, cationic organic (co)polymers in particular are recommended for e). However, these (co)polymers are also often expensive due to their complicated synthesis. On the other hand, the water solubility of the coating according to the invention may also be reduced greatly by adding a crosslinker, for example based on aziridine or diimide, or by adding a silane, silanol, siloxane, and/or polysiloxane, and/or by means of the sol-gel bridging of organic polymers and/or inorganic particles.

In many embodiments, a prerequisite for the use, for example, of a cationic polyurethane resin and/or other acid-tolerant cationic and/or nonionic organic polymers/copolymers in the aqueous composition is their suitability at comparatively low pH levels, for example at a pH in the range of 2 to 3, and the avoidance of precipitation in the aqueous composition for at least five days, or four weeks, and preferably several months (long-term stability). The complexing agents are usually necessary to avow use of the inorganic preparation as a stable solution. The pH of the aqueous compositions according to the invention is preferably in the range of 0.5 to 7, particularly preferably in the range of 1 to 5.5 or 1.5 to 4 or 2 to 3.5. In some embodiments, the pH may also be brought into the weakly acidic or neutral range due to the content of complexing agent and optionally other components.

The coating according to the invention, based on cationic polyurethane resin, for example, preferably provides high water resistance and a high level of adhesion for the subsequent coating. In some embodiment variants, these high-quality properties result only after a latency period of approximately one hour, or approximately one day, after the coating. In addition, it is preferred that this coating has a mechanical resistance which is comparatively high for such thin coatings, high transparency or turbidity, a readiness to accept white pigments and/or colored pigments, and increased chemical resistance to organic solvents, alkaline and/or acidic chemicals, and/or water, for example. Adding carbon black in particular has proven satisfactory for producing gray or black coatings.

Furthermore, in many embodiment variants the composition according to the invention may contain, in addition to or as an alternative to the at least one cationic polyurethane resin, at least one other acid-tolerant cationic or nonionic stable organic polymer/copolymer, in this regard “stability” meaning that no precipitation occurs in the composition according to the invention over a fairly long period of time, in particular for at least 5 or 20 days, or even for at least 4 weeks. It is often preferred that the aqueous composition contains at least one acid-tolerant cationic or nonionic organic polymer/copolymer which is based on and/or has a content of (meth)acrylate, acrylamide, polycarbonate, epoxy resin, ethylene oxide, polyester, polyether, styrene, urethane, vinyl, and/or vinylpyrrolidone, and which, alone and/or in a mixture e) thereof, is stable in acidic medium or optionally also in neutral medium. This means that precipitation does not occur during incorporation into the composition or after a period of time, for example after five days. The aqueous composition preferably contains at least one organic polymer/copolymer which is based on and/or has a content of (meth)acrylate, acrylamide, carbonate, epoxy, ethylene oxide, polyester, polyether, styrene, urethane, vinyl, and/or vinylpyrrolidone, and which is stable in acidic and/or neutral medium and does not result in precipitation.

The content of methacrylate, acrylate, acrylamide, carbonate, epoxy, ethylene oxide, polyester, polyether, styrene, urethane, vinyl, and/or vinylpyrrolidone in the modified passivating agent may preferably be in the range of 1 to 500 g/L, particularly preferably in the range of 8 to 420 g/L, 25 to 340 g/L, 30 to 280 g/L, 60 to 220 g/L, 80 to 180 g/L, or 100 to 140 g/L. The weight ratio of cationic polyurethane resin, which optionally may also be a copolymer and may comprise greater than 50% by weight polyurethane, to the sum of methacrylate, acrylate, acrylamide, carbonate, epoxy, ethylene oxide, polyester, polyether, styrene, urethane, vinyl, and/or vinylpyrrolidone which are not bound to a cationic polyurethane resin during the addition, including cationic polyurethane resin, is preferably in the range of at least 30%, at least 40%, at least 50%, at least 60%, at least 70%, at least 80%, at least 90% or approximately 100%. The weight ratio of polyurethane to the sum of methacrylate, acrylate, acrylamide, carbonate, epoxy, ethylene oxide, polyester, polyether, styrene, urethane, vinyl, and/or vinylpyrrolidone is preferably in the range of at least 30%, at least 40%, at least 50%, at least 60%, at least 70%, at least 80%, at least 90%, or approximately 100%.

Alternatively or additionally, the composition according to the invention may contain an acid-tolerant cationic, water-soluble, or water-dilutable epoxy resin having amino groups, and optionally may also contain phosphate groups. In addition, contents of acid-tolerant cationic copolymer based on polyester-polyurethane, polyester-polyurethane-poly(meth)acrylate, polycarbonate-polyurethane, and/or polycarbonate-polyurethane-poly(meth)acrylate, in particular as dispersions, have proven to be advantageous additives in the aqueous composition. It is therefore preferred that the composition contains acid-tolerant cationic copolymer based on polyester-polyurethane, polyester-polyurethane-poly(meth)acrylate, polycarbonate-polyurethane, and/or polycarbonate-polyurethane-poly(meth)acrylate, and/or based on acid-tolerant cationic, water-soluble, or water-dilutable epoxy resin having amino groups. All of the above-mentioned organic polymers/copolymers are preferably the only additives added to the passivating agent. The content of methacrylate and/or acrylate, in particular as acid-tolerant (meth)acrylate containing copolymers, in the aqueous composition is preferably in the range of 2 to 300 g/L, particularly preferably in the range of 5 to 220 gt, 30 to 180 g/L, 60 to 150 g/L, or 90 to 120 g/L. The acrylate and/or methacrylate portion of the copolymers may in particular be 1 to 60% by weight, 5 to 50% by weight, or 10 to 35% by weight of the copolymers. The added acid-tolerant (meth)acrylate preferably contains phosphonate and/or sulfonate groups. The content of organic polymers and copolymers is taken into account as added compounds, including additives thereof, in a compounded form in which such compounds are often commercially obtained, or produced in a form which is not processable until added to the modified passivating agent, the content of acid-tolerant organic polymers and copolymers in these products preferably being at least 95% by weight of the solids and active substances contained in these products.

The aqueous composition according to the invention is usually a dispersion or colloidal solution. The proportion of cationic polyurethane resin and optionally other acid-tolerant dispersions, colloidal solutions, and powders may possibly be so low in comparison to the dissolved components that the character of the dispersion is hardly discernible.

The composition according to the invention preferably contains at least one lubricant f). The composition according to the invention preferably contains at least one additive g), such as, for example, at least one wetting agent, one demulsifier, one emulsifier, one defoaming agent, one film-forming agent, one corrosion inhibitor, and/or one UV absorber in each case. Additives which improve wetting, limit foam formation, and allow filming of the coating are preferably selected and added to the passivating agent. The coating is preferably filmed after application, in particular during drying.

In the method according to the invention, at least one wax selected from the group composed of paraffins, polyethylenes, and polypropylenes and added to the aqueous composition, in particular at least one oxidized wax and/or at least one microcrystalline wax, may be used as lubricant f), which may sometimes also be used as a forming agent. The lubricants are preferably completely or substantially free of halogens such as fluorine, for example. It is particularly advantageous to use the wax as an aqueous dispersion and/or as a cationically, anionically, and/or sterically stabilized dispersion, since it may then be easily held in a homogeneous distribution in the aqueous composition. The melting point of the wax used as lubricant is preferably in the range of 40 to 165° C., particularly preferably in the range of 50 to 160° C., in particular in the range of 100 to 165° C. or in the range of 120 to 150° C.

The addition of an oxidized polyethylene having a melting point in the range of 100 to 150° C. is particularly preferred. Such a lubricant may be present, for example, in cationically stabilized form in water, but may also contain emulsifier.

It is particularly advantageous to also add to a lubricant having a melting point in the range of 100 to 165° C. a lubricant having a melting point in the range of 45 to 95° C., in particular in quantities of 2 to 30% by weight, preferably 5 to 20% by weight, of the total solids content, i.e., relative to solids including active substances, for example at least one polyethylene wax and at least one paraffin. The latter may also be advantageously used alone as an independent lubricant. The weight ratio of the lubricant having a higher melting point to the lubricant having a lower melting point is preferably 2:1 to 1:2, particularly preferably 3:2 to 2:3, 4:3 to 3:4, or practically or exactly 1:1.

The at least one lubricant, which at the same time may also optionally be a forming agent, is preferably present in a content of approximately zero or in the range of 0.5 to 80 g/L, 0.8 to 65 g/L, or 1 to 50 g/L, relative to solids including active substances, and particularly preferably in a content in the range of 1.5 to 40 g/L, 2 to 30 g/L, 2.5 to 24 g/L, 3 to 18 g/L, or 6 to 12 g/L in the aqueous composition. Even for a high wax content, in many embodiments a coating may have a design with good overcoatability. A lubricant and/or forming agent may be added to reduce the coefficient of friction of the coating, in particular during forming. Paraffin, polyethylene, and/or oxidized polyethylene, among others, are recommended for this purpose.

The weight ratio of the contents of acid-tolerant organic polymers/copolymers e) to the contents of lubricants f) in the aqueous composition, in particular in the bath, and in the dry film may vary over a wide range. This ratio is preferably in the range of 100:12 to 100:0.1, 100:9 to 100:0.3, or 100:7 to 100:0.5, particularly preferably in the range of 100:6 to 100:1, 100:5 to 100:2, or 100:4 to 100:3.

A wax content is particularly advantageous when the coating according to the invention is not to be coated over. The lubricant may also be added to reduce the coefficient of friction of the coating, in particular for forming, and/or as protection from scratches. Paraffin, polyethylene, polypropylene, oxidized polyethylene, and/or oxidized polypropylene, among others, is/are recommended for this purpose. The individual waxes may be present in amorphous and/or crystalline form.

The aqueous composition preferably contains multiple lubricants, in particular two or three lubricants, for which the properties of at least two of the lubricants are greatly different from one another. For forming the substrates which are coated with the preparation, at least one lubricant, in particular at least one wax, or a combination of at least two lubricants, in particular at least one being wax, with greatly different melting points or melting ranges is advantageous. In this regard, the melting point or the melting range between two lubricants may differ by at least 15° C. For simplification, only melting points are discussed below. The coefficient of friction of the coating may thus be set in such a way that optimal sliding of the coated substrates in the forming tools is ensured. This means that the sliding capability of the treated substrate surfaces is such that an optimal fit of the formed part to be produced is possible by means of an optimal hold-down pressure of the tools. If the surface of the coated substrate does not have sufficient sliding capability, there is the risk of inadvertent tapering of the substrate, usually without significant reduction of the wall thickness during forming, as the result of which the substrate in the mold may unintentionally change to smaller dimensions present at regions of the mold, which in the worst case may result in cracking of the substrate. If the coated substrate surface has an excessive sliding capability, there may be a risk that the strip which is coated according to the invention cannot be wound into a coil having sufficient stability. Furthermore, for single sheet production there is the risk that during punching, in particular of small parts, and/or during roll forming and/or edging of shaped parts, the strip feed cannot be achieved with a precise fit, resulting in inadequate dimensional stability of the shaped parts to be produced. A combination of at least two different waxes may preferably be selected in such a way that satisfactory lacquer adhesion of the coating according to the invention to the layer of the subsequently applied powder lacquer or wet lacquer based on organic solvent and/or water may be ensured.

In addition, at least one film-forming agent, such as at least one long chain alcohol, for example, may be added to the composition according to the invention. The at least one film-forming agent, which is added and/or to be added in the form of at least one long-chain alcohol, is used to improve the film formation, in particular during drying. A substantially or completely homogeneous organic film is formed from the organic film-forming agent together with at least one long-chain alcohol by filming, in particular during and/or after the release of water and other volatile components. At least one long-chain alcohol may be used for better film formation of the polymer particles of the aqueous composition during drying, in particular as a temporary softener for the polymer particles.

The content of at least one film-forming agent in the aqueous composition, in particular in the bath, may preferably be 0.01 to 60 g/L relative to solids, including active substances, particularly preferably 0.08 to 48 g/L or 0.12 to 35 g/L, very particularly preferably 0.2 to 25 g/L, 0.3 to 20 g/L, or 0.5 to 16 g/L, in particular 1 to 12 g/L, 2 to 10 g/L, 3 to 8 g/L, or 4 to 6 g/L. The weight ratio of the contents of organic film-forming agent (organic polymers/copolymers) to the contents of film-forming agents in the aqueous composition, in particular in the bath, may vary over a wide range. This ratio is preferably in the range of 100:10 to 100:0.1, 100:6 to 100:0.4, or 100:5 to 100:0.8, particularly preferably in the range of 100:4 to 100:1.2 or 100:3 to 100:1.5.

Filming is understood to mean formation of a film from a material having a high organic fraction, such as a polymer dispersion, in which primarily polymer particles transform into a uniform film at room temperature or a slightly higher temperature. This is often referred to as fusion and/or coalescence of the polymer particles. The filming occurs from an aqueous medium during drying, and optionally with plastification of the polymer particles by the remaining film-forming agents. The film formation may be enabled and/or improved by using soft synthetic resin (König pendulum hardness of less than 30 s, measured at room temperature according to DIN EN ISO 1522) and/or by adding substances which act as temporary softeners (film-forming agents, K). Film-forming agents act as specific solvents which soften the surfaces of the polymer particles and thus enable a change in their geometry due to interfusion of the organic particles, but in particular are not highly volatile, and in particular largely evaporate after the water has evaporated, and preferably do not permanently remain in the film. The resulting film is often free or essentially free of pores, and is not able to incorporate dissolved and/or undissolvable particles such as inorganic particles, for example. In this regard, it is advantageous for this softener on the one hand to remain in the aqueous composition for long enough to be able to act on the polymer particles for a long period of time, and on the other hand to subsequently evaporate and thus escape from the film. In a suitable film formation a transparent film is formed, but not a milky white or even a powdery film, which is a sign of defective film formation. For absolutely perfect film formation, the temperature of the wet film applied to a surface must be above the minimum film formation temperature (MFT). Only then are the polymer particles soft enough to coalesce. In this regard, it is particularly advantageous when the film-forming agents, as temporary softeners, cause little or no change in the pH of the aqueous composition.

The selection of the film-forming agents is not simple; often, a mixture of at least two film-forming agents is helpful. The film-forming agents preferably have a boiling point at 760 mm Hg in the range of 140 to 400° C., in particular in the range of 150 to 340° C., 160 to 310° C., or 170 to 280′C, and/or an evaporation number for ether=1 in the range of 100 to 5000, in particular in the range of 120 to 4000, 135 to 2800, or 150 to 1600. So-called long-chain alcohols, preferably those containing 4 to 22 C atoms or 6 to 18 C atoms, particularly preferably containing 6 to 14 or 8 to 12 C atoms, are particularly advantageous as film-forming agents. These alcohols may also be alkoxylated. The alcohols are preferably at least one glycol and/or derivatives thereof, for example on the basis of butanediol; for example on the basis of butyl glycol, such as butyl diglycol; for example on the basis of ethylene glycol, such as ethylene glycol monobutyl ether, ethylene glycol monoethyl ether, ethylene glycol monomethyl ether, ethyl glycol propyl ether, ethylene glycol hexyl ether, diethylene glycol methyl ether, diethylene glycol ethyl ether, diethylene glycol butyl ether, diethylene glycol hexyl ether, tripropylene glycol ethyl ether; and/or for example on the basis of propylene glycol, such as propylene glycol monomethyl ether, dipropylene glycol monomethyl ether, tripropylene glycol monomethyl ether, propylene glycol monobutyl ether, dipropylene glycol monobutyl ether, tripropylene glycol monobutyl ether, propylene glycol monopropyl ether, dipropylene glycol monopropyl ether, tripropylene glycol monopropyl ether, and/or propylene glycol phenyl ether.

In contrast to filming, which may occur at comparatively low temperatures, for example in the range starling at 3° C., for chemically or chemically-thermally crosslinking organic coatings temperatures of at least 50° C. are usually necessary for crosslinking. Film-forming agents are preferably selected and added in a quantity so that the composition films preferably at temperatures above 5° C., particularly preferably above 10° C., above 20° C., or above 40° C., in particular above 60° C., above 80° C., above 100° C., or above 120° C. Similarly, it is preferred that the minimum film formation temperature for the synthetic resins, including film-forming agents, results in filming at temperatures above 5° C., particularly preferably above 10° C., above 20° C., or above 40° C., in particular above 60° C., above 80° C., above 100° C., or above 120° C. The subsequent drying preferably takes place at slightly higher temperatures (at least 10°, 15°, or 20° C.) or at much higher temperatures (at least 30°, 50°, 70°, 90°, or 110° C.) than the minimum film formation temperature for the synthetic resins, including film-forming agents. Water and optionally present organic solvents escape during drying. Film formation then usually begins, in which the organic substances, optionally in particulate form, are able to pack more closely together, become softer due to the higher temperature, and form a dosed film. It is particularly preferred when a significant portion of the filming has already taken place at room temperature.

In individual embodiments, the coalescence of the polymer particles may also occur without addition of film-forming agent, for example when the König pendulum hardness of the organic polymer additives is less than 10 s.

Furthermore, in individual embodiments at least one crosslinker may also be added to the composition according to the invention. Such a crosslinker may assist in making a filmed coating, which is only physically dried and homogenized, stronger due to chemical reactions and more resistant. The resistance of filmed coatings to water and chemicals is usually further improved in this way. For this purpose, it is advantageous when the added organic polymer/copolymer contains COOH groups and/or other groups that are suitable for crosslinking.

Specific crosslinkers may be selected as a function of the drying and/or crosslinking temperatures. Organic crosslinkers based on melamine formaldehyde are usually used in a temperature range of approximately 120° to approximately 250° C., preferably in the range of 140° to approximately 200° C., while the other organic crosslinkers are usually or commonly used in a temperature range of approximately 50° to approximately 120° C., preferably in the range of approximately 60° to approximately 110° or to approximately 100° C. The latter crosslinkers are referred to herein as organic low-temperature crosslinkers. For example, at least one preferably polyfunctional aziridine (active in the range of 40° to 250° C., for example), at least one carbodiimide, such as at least one polycarbodiimide (active in the range of 80° to 250° C., for example), at least one preferably blocked isocyanate (active in the range of 80° to 250° C., for example), at least one melamine formaldehyde (active in the range of 120° to 250° C., for example), at least one triazine (active in the range of 100 to 250° C., for example), and/or at least one diamine (active in the range of 60 to 250°, for example) may be used as crosslinker. However, a blocked isocyanate may be disadvantageous if this causes the reaction to proceed extremely slowly, thus making it unsuitable for the low-temperature drying of conveyorized treatments. In comparison to a crosslinker based on melamine, a crosslinker based on triazine has the advantage that formaldehyde is not cleaved during the thermal reaction (drying, crosslinking).

The following may preferably be used as the at least one crosslinker: organic crosslinkers such as adipine dihydrazide, organic crosslinkers based on aziridine, for example polyfunctional polyaziridine, based on an azo compound, based on diamine, based on diimide, for example multifunctional polycarbodiimides, based on formaldehyde, for example urea formaldehyde and/or melamine formaldehyde, based on imidazole, for example 2-ethyl-4-methylimidazole, based on isocyanate, based on isocyanurate, based on melamine, for example hexamethoxymethyl melamine, based on peroxide, based on triazine, for example tris-(alkoxycarbonylamino)triazine, and/or based on triazole. A crosslinker based on zirconium carbonate which is stable and/or stabilized in acidic or neutral medium may also optionally be used as crosslinker.

The crosslinker may be suitable in particular for at least partially crosslinking at least one of the synthetic resins contained in the composition of the coating, and/or for chemically reacting with at least one of the contained synthetic resins. The crosslinking, including the chemical reaction, may occur In particular by chemical and/or chemical-thermal means. The crosslinker may also often act as a reaction catalyst and/or sometimes as a corrosion inhibitor. The crosslinker may assist in improving the resistance against corrosive media such as chemicals and weathering effects and against mechanical stresses, improving or ensuring the stability of the discernible color of the substrate, in particular for zinc and zinc-containing surfaces under high humidity and/or wet room exposure, and avoiding or greatly reducing darkening of a transparent coating. In some embodiments, the crosslinker may be present in stable form in the aqueous composition in order to remain homogeneously distributed and dispersed therein over the long term, and/or to remain with little or no reactivity at temperatures below approximately 40 or 45° C., for example, and thus stable under storage, but above approximately 45 or 50° C., for example, to allow the desired reaction with the synthetic resins after the coating is applied.

The weight ratio of the content of organic film-forming agent to the content of crosslinkers in the aqueous composition, in particular in the bath, may vary over a wide range. This ratio is preferably in the range of 100:10 to 100:0.1, 100:5 to 100:0.2, or 100:2.5 to 100:0.3, particularly preferably in the range of 100:2 to 100:0.5, 100:1.6 to 100:0.8, or 100:1.4 to 100:1.

In this regard, the content of the at least one crosslinker may vary greatly, depending on the type of crosslinker, the synthetic resins involved, and/or the desired coating properties, and/or also the combination of various crosslinkers in the aqueous composition. The at least one crosslinker is preferably selected in such a way that there is no or essentially no starting of the crosslinking reactions in the aqueous composition before the coating is applied. Optional addition of at least one reaction blocker and/or stabilizer in each case, which help(s) suppress the crosslinking reactions in the aqueous composition before the coating is applied, is advantageous.

The content of at least one crosslinker in the aqueous composition is preferably in the range of 0.2 to 80 g/L, relative to solids, including active substances, or 0.5 to 50 g/L, particularly preferably in the range of 1.5 to 35 g/L, 3 to 20 g/L, or 6 to 10 g/L.

In addition, it is advantageous to add at least one wetting agent to allow application of the wet film which is uniform in the planar extension and in the layer thickness, and also in a seal-tight manner and without flaws. In principle, many wetting agents are suitable for this purpose, preferably acrylates, silanes, polysiloxanes, silicone surfactants, and/or alcohols, which lower the surface tension of the aqueous composition and assist in wetting the entire metallic surface. The wetting agent may be added in an overall quantity in the range of 0.1 to 10 g/L, in particular 1 to 4 g/L.

Furthermore, at least one defoaming agent may also be added to the composition according to the invention, preferably in an overall quantity in the range of 0.1 to 10 in particular 1 to 4 g/L. In some cases the addition of a defoaming agent is necessary to limit foam formation. This is because with fairly heavy foam formation, bubbles may possibly remain in the coating and form pores. In principle, the helpful additives, including the lacquer additives often used for lacquers, are basically known to one skilled in the art.

The aqueous composition according to the invention preferably contains cations of aluminum, chromium(III), and/or zinc, and/or at least one compound containing aluminum, chromium(III), and/or zinc, in some embodiments also cations of aluminum, chromium(III), iron, manganese, and/or zinc, and/or at least one compound containing aluminum, chromium(III), iron, manganese, and/or zinc. The starting composition according to the invention, i.e., in particular the fresh concentrate and/or the fresh bath composition, and often also the replenishment solution which is added to the bath as needed during use in particular to keep the bath ready for operation, in a very large number of embodiments preferably has a significant content of cations and/or at least one compound of aluminum, chromium(ill), iron, manganese, and/or zinc. The composition preferably has an overall content of cations of iron and/or manganese, and/or at least one compound having a content of iron and/or manganese, in the range of 0.1 to 20 g/L, 0.5 to 12 g/L, 1 to 8 g/L, or 2 to 5 g/L, calculated as metal. In many embodiments, in addition to the cations and/or compounds of aluminum, chromium, iron, manganese, titanium, zinc, and/or zirconium the composition has little or no significant content of further heavy metal cations and/or heavy metal compounds besides those just named. The composition also often contains no chromium. However, the composition may often absorb additional cations and/or compounds when in contact with the facilities or with the metallic surfaces to be coated, and/or as the result of entrainment of impurities. Therefore, the original chromium-free composition may also contain traces, or in isolated cases, even small amounts of chromium, chromium compounds, and/or cations/compounds, for example, from other steel refiners. The composition preferably has an overall content of cations of aluminum, chromium(III), and/or zinc and/or at least one compound having a content of aluminum, chromium(III), and/or zinc in the range of 0.5 to 80 g/L, 1 to 50 g/L, or 2 to 30 g/L, calculated as metal, or particularly preferably has an overall content of cations of aluminum, chromium(III), iron, manganese, and/or zinc and/or at least one compound having a content of aluminum, chromium(III), iron, manganese, and/or zinc in the range of 0.5 to 80 g/L, 1 to 50 g/L, or 2 to 30 g/L, calculated as metal. The contents of cations of aluminum, chromium(III), and/or zinc and/or at least one compound containing aluminum, chromium(III), and/or zinc, or the contents of cations of aluminum, chromium(III), iron, manganese, and/or zinc or at least one compound containing aluminum, chromium ill), iron, manganese, and/or zinc very particularly preferably are in the range of 3 to 25, 4 to 20, 5 to 15, 6 to 12, or 8 to 10 g/L, calculated as metal. A content of chromium(III) as cations and/or compounds is particularly preferably approximately zero or in the range of 0.01 to 30, 0.1 to 20, 0.3 to 12, 0.5 to 8, 0.8 to 6, or 1 to 3 g/L, calculated as metal. With regard to the cations and/or the metal-containing compounds, the composition according to the invention is composed only, or essentially only, of cations of aluminum, chromium(III), and/or zinc, and/or of at least one compound containing aluminum, chromium(III), and/or zinc, in particular when alkali metals, titanium, hafnium, zirconium, and compounds thereof are excluded. The content of chromium (VI) as cations and/or compounds may in particular be zero, approximately zero, or in the range of 0.01 to 8, 0.05 to 5, 0.1 to 3, or 0.3 to 1 g/L, calculated as metal. Preferably at least 60%, at least 80%, at least 90%, or even at least 95% of these cations and compounds are based on aluminum and/or zinc, when alkali metals, titanium, hafnium, zirconium, and compounds thereof are excluded. The content of such cations and compounds may be varied within a wide range, and optionally may be present in a complexed state. It may also be taken into account that, due to the pickling action of the main component of the metallic surface, for example zinc for galvanized surfaces, iron for steel surfaces, and aluminum for aluminum surfaces, addition is carried out in smaller quantities over a fairly long throughput time, because the main component is replenished solely due to the pickling action. It is particularly preferred that the composition according to the invention essentially contains only cations of alkali metal(s), aluminum, titanium, zinc, and/or zirconium, or that only these cations are added to the composition. With regard to the cations and/or metal-containing compounds, it is particularly preferred that only cations and/or compounds of alkali metal(s), aluminum, chromium(ill), titanium, zinc, and/or zirconium are added to the composition according to the invention. It is very particularly preferred that only or essentially only alkali metal(s), titanium, and zinc, or alkali metal(s), titanium, and aluminum, are contained in the composition according to the invention or are added thereto. With regard to the cations and/or metal-containing compounds, it is particularly preferred that only cations and/or compounds of alkali metal(s), aluminum, chromium(III), titanium, zinc, and/or zirconium are added to the composition according to the invention. In this regard, optionally other types of cations, in particular trace impurities, entrained impurities, and/or impurities pickled out of devices and/or substrates may appear.

In most embodiments, the content of cations and/or at least one compound of alkaline earth metals is approximately zero or in the range of 0.001 to 1.5 g/L, 0.003 to 1 g/L, 0.01 to 0.5 g/L, or 0.03 to 0.1 g/L, calculated as the respective metal. When the content of these cations/compounds is very low, no adverse effects are expected. When the content of these cations/compounds is too high, the stability of the solution is jeopardized, and losses in corrosion protection may occur. Content of alkaline earth metal has a disruptive effect when this results in precipitation. Precipitation with alkaline earth metal may easily occur due to the content of fluoride (including complex fluoride). In most embodiments, the content of cations and/or at least one compound of at least one alkali metal is approximately zero or in the range of 0.001 to 5 g/L, 0.01 to 2 g/L, 0.1 to 1 g/L, or 0.02 to 0.2 g/L, calculated as the respective metal. However, small amounts of alkali metal and alkaline earth metal are often not disruptive when they are present in the same range as in tap water.

The aqueous composition according to the invention preferably has a phosphate content in the range of 1 to 250 g/L, calculated as PO₄. The phosphate content of the composition is particularly preferably in the range of 2 to 200 g/L, 3 to 120 g/L, 4 to 100 g/L, 5 to 80 g/L, 6 to 65 g/L, 7 to 50 g/L, 8 to 40 g/L, 9 to 30 g/L, 10 to 22 g/L, or 12 to 18 g/L, calculated as PO₄. In particular, the phosphate content of the composition is in the range of 0.75 to 185 g/L, 1.5 to 150 g/L, 2.2 to 90 g/L, 3 to 75 g/L, 4 to 60 g/L, 5 to 50 g/L, 6 to 40 g/L, 7 to 30 g/L, 8 to 22 g/L, or 10 to 16 g/L, calculated as P₂O₅. The corrosion protection is low when the phosphate content is excessively low. An addition of phosphate is preferably high enough that a distinct improvement in the corrosion protection and in the surface appearance is obtained. When the phosphate content is too high, matte coatings may form. The ratio of Al to PO₄ for compositions whose content of cations and/or inorganic compounds is selected from those based on aluminum, chromium, iron, manganese, and/or zinc, predominantly those based on aluminum, is preferably in the range of 1:10 to 1:25, in particular in the range of 1:12 to 1:18. The ratio of Zn to PO₄ for compositions whose content of cations and/or inorganic compounds is selected from those based on aluminum, chromium, iron, manganese, and/or zinc, or based on aluminum, chromium, and/or zinc, predominantly those based on zinc, is preferably in the range of 1:4 to 1:20, in particular in the range of 1:6 to 1:15. Phosphate is preferably added as at least one compound selected from monophosphates (orthophosphates based on PO₄³⁻, monohydrogen phosphates based on HPO₄²⁻, dihydrogen phosphates based on H₂PO₄⁻), diphosphates, triphosphates, phosphorus pentoxide, and/or phosphoric acid (orthophosphoric acid, H₃PO₄). An addition of phosphate may be an addition of monometal phosphate, an addition of phosphoric acid and metal, of phosphoric acid and metal salt/metal oxide, of diphosphate, of triphosphate, of polyphosphate, and/or of phosphorus pentoxide to water or to an aqueous mixture.

When at least one orthophosphate, at least one triphosphate, and/or phosphoric add, for example, is/are added, a corresponding chemical equilibrium is established, in particular depending on the pH and the concentrations of these additives. The more acidic the aqueous composition, the greater the shift of the chemical equilibrium toward orthophosphoric acid (H₃PO₄), and at higher pH values the equilibrium shifts toward tertiary phosphates based on PO₄³⁻. Within the meaning of the present patent application, in principle a large number of different orthophosphates may be added. The orthophosphates of aluminum, chromium, and/or zinc have proven to be particularly suitable. Preferably at least one orthophosphate is added to the aqueous composition, with a total addition in the range of 1 to 250 g/L, calculated as PO₄, particularly preferably in the range of 2 to 200, 3 to 120, 4 to 90, 5 to 75, 6 to 60, 8 to 50, or 10 to 30 g/L. The total addition corresponds to the overall content.

The aqueous composition may be prepared using phosphoric add anhydride P₂O₅, a phosphorus-containing add, at least one salt and/or ester of the orthophosphoric add, and/or at least one salt and/or ester of a condensed phosphoric add, optionally together with at least one metal, carbonate, oxide, hydroxide, and/or salt such as nitrate, for example, together with phosphoric add.

The addition of at least one complexing agent may be advantageous and/or necessary when the pH is to be raised, for dilution of the composition with water, for absorbing quantities of ions and/or compounds, in particular further types of ions and/or additional compounds, and/or for stabilizing the composition, in particular for preventing and/or triggering precipitation. The complexing agent assists in bringing the inorganic components into solution and holding them stable in solution. The complexing agent is used to keep dissolved in the composition an elevated content of compounds, in particular cations such as aluminum, chromium, iron, manganese, or zinc, and/or cations which are entrained, or pickled out of facilities and/or out of the metallic surfaces. This is because precipitation of, for example, fluorides, oxides, hydroxides, and/or phosphates, in particular aluminum, iron, manganese, and/or zinc, may be disruptive due to the increased formation of sludges and/or due to the fact that precipitation impairs or even prevents use of the composition for coating. When precipitation occurs, in some situations complexing agent may be added if needed to terminate the precipitation. The at least one complexing agent is used in particular to complex cations such as aluminum, chromium, iron, magnesium, manganese, titanium, zinc, and/or zirconium, and thus to stabilize the solution or suspension, in particular at lower acidity. In addition, in many embodiments, adding at least one complexing agent has proven to have a more or less corrosion-protective effect. When complexing agent(s) is/are added anew, and/or when there is an elevated content of complexing agent(s) in the aqueous composition, it may be advantageous in some cases to also add at least one compound to the composition which is approximately neutral or basic in order to set a higher pH. Within the meaning of the present patent application, the term “complexing agent” also includes chelating agents (see definition of “complexing agent” in Römpp).

As complexing agent, in particular at least one compound based on complexing alkoxide, based on carboxylic add, based on phosphonic add, and/or based on an organic compound such as phytic add, and/or based on a phenol compound such as tannic add is used, particularly preferably at least one compound selected from compounds comprising phosphonic adds, complexing carboxylic adds, phytic add, adds based on polyphenol, and derivatives thereof. This also includes in particular at least one compound selected from compounds comprising phosphonic adds, diphosphonic adds, alkylene phosphonic adds, phytic add, monocarboxylic adds, dicarboxylic adds, tricarboxylic adds, aminocarboxylic adds, hydroxycarboxylic acids, acids based on polyphenol, and derivatives thereof. In some embodiments it has proven to be particularly advantageous to add two or three distinctly different complexing agents, for example those based on phosphonic acid and on hydroxycarboxylic acid.

The higher the content of at least one complexing agent, in some embodiments the higher the pH of the composition may be adjusted as a function of the quantity of cations. The content of complexing agent(s) may be varied over a wide range. The aqueous composition according to the invention preferably has an overall content of at least one complexing agent in the range of 0.1 to 60 g/L. The overall content of at least one complexing agent is particularly preferably in the range of 0.3 to 50 g/L, 1 to 40 g/L, 1.5 to 30 g/L, 2 to 24 g/L, 2.5 to 18 g/L, 3 to 14 g/L, 4 to 10 g/L, or 6 to 8 g/L. The complexing agent content is preferably high enough that the composition is a stable solution, and that stable solutions are obtained, optionally also when diluted with water. If the content of complexing agent is too low, depending on the quantity of cations an increase in pH and/or an increase in the content of cations and/or compounds may lead to precipitation, thus possibly resulting in deposits and also sludge formation. If the content of complexing agent is too high, the corrosion protection and/or the formability may be impaired.

in the method according to the invention, at least one phosphonic acid, at least one salt of a phosphonic acid, and/or at least one ester of a phosphonic acid may preferably be added to the aqueous composition. The aqueous composition preferably has a content of at least one compound based on phosphonic acid in the range of 0.1 to 60 particularly preferably in the range of 0.3 to 50 g/L, 1 to 40 g/L, 1.5 to 26 or 2 to 18 g/L. At least one compound based on phosphonic add, for example a diphosphonic add and/or a diphosphonic add containing an alkyl chain and optionally further groups, for example 1-hydroxyethane-1,1-diphosphonic add (HEDP), amino-tris-(methylenephosphonic add) (ATMP), ethylenediamine-tetra(methylenephosphonic add) (EDTMP), diethylenetriamine-penta(methylenephosphonic add) (DTPMP), diethylenetriamine-penta-(methylenephosphonic add) (DTPMP), hexamethylenediamine-tetramethylenephosphonic add (HDTMP), hydroxyethylamino-di(methylenephosphonic add) (HEMPA), and/or phosphonobutane-1,2,4-tricarboxylic add (PBTC) is/are particularly preferred.

In the method according to the invention, the composition preferably contains in each case at least one complexing carboxylic add and/or a derivative thereof: for example, at least one compound based on formic add, succinic add, citric add, maleic add, malonic add, lactic add, oxalic add, or tartaric add, including the derivatives thereof. The at least one carboxylic add may have a complexing and/or corrosion protection effect. In some embodiments, the aqueous composition preferably has a content of at least one compound based on complexing carboxylic add in the range of 0.1 to 60 g/L, particularly preferably in the range of 0.3 to 50 g/L, 1 to 40 g/L, 1.5 to 26 g/L, or 2 to 18 g/L.

The composition according to the invention preferably contains at least one compound based on adds of polyphenol, for example a gallic acid, a tannic acid, and derivatives thereof, for example salts and esters thereof and their derivatives.

The aqueous composition preferably contains at least one complexing compound based on phytin and/or polyphenol, having an overall content of these compounds in the range of 0.05 to 30 g/L, particularly preferably in the range of 0.3 to 25 g/L or 1 to 20 g/L, very particularly preferably in the range of 1.5 to 15 g/L or 2 to 10 g/L.

In the method according to the invention, the aqueous composition preferably has an overall content of least one titanium and/or zirconium compound of at least 0.1 g/L, calculated as Ti metal. In particular, this overall content is in the range of 0.1 to 50 g/L, 0.5 to 30 g/L, or 1 to 15 g/L, calculated as Ti metal. The titanium and/or zirconium compound may optionally be added in whole or in part as at least one complex fluoride, and/or may be present in the aqueous composition in whole or in part as at least one complex fluoride. The aqueous composition particularly preferably has an overall content of at least one titanium and/or zirconium compound in the range of 1 to 250 g/L, 2 to 180 g/L, 3 to 130 g/L, 4 to 100 g/L, 5 to 80 g/L, 6 to 60 g/L, 8 to 50 g/L, 10 to 40 g/L, 15 to 30 g/L, or 20 to 25 g/L, calculated as Ti metal. The composition preferably has an overall content of at least one titanium and/or zirconium compound, based on complex fluoride, in the range of 1 to 200 g/L, calculated as the respective compound. When a zirconium compound is used, its content is converted to the corresponding titanium compound content on a molar basis, and expressed as Ti metal content. In individual cases, at least one compound may also be added as a titanium and/or zirconium compound which is usually stable only in basic medium, but which is also stable in acidic medium when at least one complexing agent, for example a phosphonate, and/or at least one protective compound, for example a surfactant, is also added, this compound then being present in complexed form and/or protected in the aqueous composition. It is particularly preferred that only at least one titanium and/or zirconium compound based on complex fluoride is added as fluoride-containing compound. In many embodiments, the composition in each case contains at least one complex fluoride and/or its salt of aluminum, titanium, zinc, and/or zirconium, which is present as an MeF₄ and/or MeF₆ complex, for example. In particular for aluminum-containing metallic surfaces, it is important that complex fluoride be added in a quantity that is not too low, in order to produce an increased pickling action. The addition and content of at least one titanium and/or zirconium compound are preferably high enough that good bare corrosion protection and, if necessary, also good lacquer adhesion are present for the subsequent lacquer/primer coating. If the content of at least one titanium and/or zirconium compound is too high, and if insufficient complexing agent(s) is/are present, this may easily result in instability of the bath, and thus, precipitation. This is because a fluoride or a complex fluoride may also act as a complexing agent. However, within the meaning of the present patent application, fluoride and complex fluoride are not regarded as complexing agents. The addition and content of a titanium compound has proven to be advantageous in particular for improving the corrosion protection. The addition and content of a zirconium compound has proven to be advantageous in particular for hot dip-galvanized surfaces for improving the lacquer adhesion. In many embodiments, the titanium and/or zirconium compound according to the invention may be at least one appropriate complex fluoride, and/or at least one complexed substance, for example at least one titanium chelate, in particular at least one titanium alkoxide, the less reactive titanium and/or zirconium compounds being preferred. The weight ratio of silane/silanol/siloxane/polysiloxane to complex fluoride based on titanium and/or zirconium, calculated as added silane and/or polysiloxane or optionally converted to H₂TiF₆ on a molar basis, is preferably less than 2:1, less than 1.5:1, less than 1:1, or less than 0.5:1,

In individual embodiments, the composition according to the invention contains at least one titanium- and/or zirconium-containing fluoride-free compound such as a chelate, for example. This compound may be used to bring titanium and/or zirconium into the composition in a different form, and is therefore one option for a source of such a compound. Such a compound may greatly improve the corrosion protection and keep the aqueous composition stable in solution. The composition according to the invention preferably has a content of titanium chelates and/or zirconium chelates in the range of 0.1 to 200 g/L, particularly preferably in the range of 1 to 150 g/L, 3 to 110 g/L, 5 to 90 g/L, 7 to 70 g/L, 10 to 50 g/L, or 15 to 30 g/L.

In particular, the content of titanium and/or zirconium compounds is selected in such a way that a content of titanium and/or zirconium in the range of 3 to 60 mg/m², 5 to 45 mg/m², or 10 to 35 mg/m², calculated as Ti metal and determined by X-ray fluorescence analysis, remains on the metallic surface. Such a compound is added in particular when no other titanium- and/or zirconium-containing compound is/are present in the composition according to the invention, it is particularly advantageous that at least one titanium- and/or zirconium-containing compound is/are present in the composition according to the invention. Dihydroxo-bis-(ammonium lactate)titanate in particular may be used as such a compound.

In the method according to the invention, the aqueous composition preferably has, for example, no fluoride content or a free fluoride content F_{free} in the range of 0.01 to 5 g/L, and/or a total fluoride content Fₜₒₜₐₗ in the range of 0.5 to 80 g/L. The composition particularly preferably has a free fluoride content F_{free} in the range of 0.1 to 3.5 g/L, 0.3 to 2 g/L, or 0.5 to 1 g/L, and/or a total fluoride content Fₜₒₜₐₗ in the range of 1 to 50 g/L, 1.5 to 40 g/L, 2 to 30 g/L, 2.5 to 25 g/L, 3 to 20 g/L, 4 to 16 g/L, 5 to 12 g/L, or 7 to 10 g/L. In many embodiments, no hydrofluoric acid, monofluoride, and/or bifluoride is/are added to the composition according to the invention. In that case, a content of hydrofluoric add, monofluoride, and/or bifluoride in the composition according to the invention may result from at least one complex fluoride and/or derivative thereof in small quantities, based only on the equilibrium conditions. In individual embodiments, hydrofluoric add, monofluoride, and/or bifluoride having an overall content of 0.01 to 8 g/L, calculated as free fluoride F_{free}, in particular 0.1 to 5 g/L or 0.5 to 3 g/L, is/are added to the composition according to the invention.

Within the scope of the present invention, the term “silane” is intended to also include the hydrolysis, condensation, polymerization, and reaction products thereof, i.e. in particular silanols, siloxanes, and optionally polysiloxanes. The term “polysiloxane” is intended to also include the condensation, polymerization, and reaction products of polysiloxane.

In the method according to the invention, in individual embodiments the composition has a content of at least one silane/silanol/siloxane/polysiloxane or at least one silane/silanol/siloxane, preferably with a content of at least one silane/silanol/siloxane/polysiloxane of approximately zero or in the range of 0.1 to 50 g/L, 0.5 to 30 g/L, 1 to 20 g/L, 2 to 10 g/L, or 3 to 6 g/L, calculated as Si metal. If the silane/silanol/siloxane/polysiloxane content is too low, in some embodiments the corrosion protection of the coating may be impaired, in particular for hot dip-galvanized surfaces. If the silane/silanol/siloxane/polysiloxane content is too high, this may result in instability of the solution, and thus, precipitation and/or incomplete wetting of the metallic surface. An addition and content of at least one surfactant (wetting agent) may prevent problems when a high content of silane/silanol/siloxane/polysiloxane is present, but may also impair the corrosion protection of the produced coating. It has been found that a content of at least one surfactant may sometimes have a great influence on the properties of the coating according to the invention, in particular for corrosion protection. The corrosion protection may be greatly improved, in particular for lower levels of quality of hot dip-galvanized (HOG) substrates. For this purpose, at least one nonionic surfactant is preferably added, and alternatively or additionally, optionally also at least one cationic surfactant. A second surfactant may optionally act as a solubilizer. A silane/silanol/siloxane and/or a polysiloxane often greatly improve(s) the corrosion protection. In particular, in most embodiments at least one silane is added, while in some individual embodiments at least one polysiloxane is added, either alone or in addition to at least one silane.

The composition preferably contains in each case at least one silane/silanol/siloxane/polysiloxane, in particular based on alkoxysilane, amidosilane, aminosilane, bis-silylsilane, epoxysilane, fluorosilane, imidosilane, iminosilane, isocyanatosilane, (meth)acrylate silane, and/or vinyl silane. Among these silanes/silanols/siloxanes/polysiloxanes, those based on aminosilanes have proven to be particularly suitable in several embodiments, although the other silanes/silanols/siloxanes named here may also be important, depending on the embodiment. These silanes/silanols/siloxanes contribute to an increased pH when silanes and/or their derivatives, which may be present after further condensation, in particular at a slightly increased pH, for example based on silanes/silanols/siloxanes having at least one nitrogen-containing group such as at least one amino group (aminosilane), amido group, imino group, and/or imido group in each case, and/or having at least one ammonium group with acceptance of protons, are added. The pH may also be increased in this manner, for example from original values in the range of 1 to 2 or 1.5 to 3 to values in the range of 1.5 to 4. A content of silanes/silanols/siloxanes having at least one nitrogen-containing group, such as at least one amino group (aminosilane), amido group, imino group, and/or imido group in each case, is particularly preferred. The alkylsilanes may in particular be di-, tri-, and/or tetrafunctional. The alkylsilanes may in particular contain no organically functional side chain, or in particular may contain a terminal nitrogen-containing group. The alkylsilanes may optionally contain no side chain, but may also contain at least one side chain with a chain length of up to ten C atoms. In some embodiments, the aqueous composition in each case preferably contains an addition and content of at least one compound based on at least one silane/silanol/siloxane/polysiloxane a) containing at least one nitrogen-containing group, for example at least one amino group or ammonium group, b) based on bis-silane(s), c) based on epoxysilane(s), d) based on fluorosilane(s), e) based on isocyanatosilane(s), f) based on (meth)acrylate silane(s), g) based on vinyl silane(s), h) based on alkoxysilanes, and/or i) based on alkylsilane, in each case in the range of 0.5 to 160 g; L, particularly preferably in the range of 1 to 120, 2 to 80, 3 to 50, 5 to 35, or 8 to 20 g/L, calculated as Si metal. Particularly preferred silanes are 3-aminopropyltriethoxysilane and/or 3-aminopropyltrimethoxysilane (APS), N-[2-(aminoethyl)]-3-aminopropyltrimethoxysilane (AEAPS), methylsilane, butylsilane, epoxysilane, and/or tetraethoxysilane (TEOS). In some silanes/silanols/siloxanes/polysiloxanes, higher fluoride contents may result in formation of HF gas.

Siloxanes and/or polysiloxanes may also be formed, depending on the type and degree of the polymerization, for example a condensation. Alternatively, it has been shown that also the addition and content of at least one polysiloxane or also the addition of a combination based on sane and polysiloxane may be advantageous.

In the method according to the invention, the composition preferably contains at least one organic monomer/oligomer/polymer/copolymer. Within the meaning of the present patent application, the term “copolymer” also includes block copolymers and/or graft copolymers. The addition and content of at least one such acid-tolerant organic compound, preferably at least partially based on acid-tolerant (meth)acrylate, carbonate, epoxy, ethylene, polyester, and/or urethane, is important in some embodiments in order to improve the corrosion protection, lacquer adhesion, formability, friction, and/or absorption of oil-containing impurities from the oiled and/or soiled metallic surface. The latter is often used to avoid cleaning of oiled and/or soiled metallic surfaces. In so doing, a small quantity of skin pass rolling agent from a skin pass rolling operation, a small quantity of slushing oil from oiling for temporary rust protection, and/or a small quantity of forming oil from a forming operation may possibly be absorbed on a metallic surface which is coated according to the invention. The aqueous composition preferably has a content of at least one acid-tolerant organic monomer/oligomer/polymer/copolymer in the range of 1 to 500 g/L, particularly preferably in the range of 5 to 450 g/L, 15 to 400 g/L, 25 to 300 g/L, 40 to 280 g/L, 60 to 260 g/L, 80 to 240 g/L, 100 to 220 g/L, 120 to 200 g/L, 140 to 180 g/L, or 150 to 160 g/L. The content of acid-tolerant organic monomer/oligomer/polymer/copolymer is preferably high enough that the formability is improved, in particular the friction during forming being significantly reduced. The content of acid-tolerant organic monomer/oligomer/polymer/copolymer is preferably in a range such that the stability of the aqueous composition is maintained, and a good surface appearance of the coating is ensured, so that in particular no matte and/or streaked coatings result. Coatings that are transparent and/or with little or no color are particularly preferred.

The composition preferably contains at least one acid-tolerant organic monomer/oligomer/polymer/copolymer based on and/or having a content of (meth)acrylate, carbonate, epoxy, ethylene, polyester, and/or urethane. Each of these named components may also be at least one component of a copolymer or copolymers. The aqueous composition preferably has a content of at least one acid-tolerant organic monomer/oligomer/polymer/copolymer based on a) (meth)acrylate, b) carbonate, c) epoxy, d) ethylene, e) polyester, and/or f) urethane, in each case in the range of 0.5 to 300 g/L, particularly preferably in the range of 2 to 250 g/L, 5 to 200 g/L, 8 to 140 g/L, 12 to 100 g/L, or 16 to 60 g/L.

It is particularly preferred to add at least one cationic polyurethane resin which is a polymer and/or copolymer and which optionally preferably contains a portion of polyethylene and/or at least one other polymer.

It is particularly preferred to add modified anionic polyacrylate which is a polymer and/or copolymer and which optionally preferably contains a portion of polystyrene and/or at least one other polymer.

However, the organic polymers and/or copolymers to be added should allow stability of the aqueous composition for at least five days.

In the method according to the invention, the composition preferably contains in each case at least one inorganic and/or organic compound in particle form. Organic particles may be present in particular as a component of an organic polymer/copolymer. The particles often have particle sizes in the range of 10 to 300 nm. In some embodiments, the aqueous composition preferably has a content of inorganic and/or organic particles in the range of 0.05 to 120 g/L, particularly preferably in the range of 0.1 to 80 g/L, 0.3 to 50 g/L, 1 to 30 g/L, 1.5 to 15 g/L, or 2 to 10 g/L.

The composition according to the invention preferably contains at least one inorganic compound in particle form based on Al₂O₃, SO₂, TiO₂, ZnO, ZrO₂, mica, day mineral, carbon black, and/or corrosion protection particles, which have an average particle diameter less than 300 nm as measured by a scanning electron microscope. The particles are used in particular as white pigment(s), as colored pigment(s), and/or as corrosion protection pigment(s). The inorganic particles, such as those based on Al₂O₃, SiO₂, TiO₂, ZrO₂, mica, and/or day mineral, often act as particles having a barrier effect, optionally with binding to the metallic surface. They may be used as white pigments, for example, in order to cover the metallic surface and produce a bright film. However, colored pigments may also be added, if necessary. For example, ZnO particles may have a corrosion protection effect until they are possibly dissolved. The corrosion protection particles may in particular be based, for example, on silicate, primarily alkali silicate and/or alkaline earth silicate, or also based on phosphates, phosphosilicates, molybdates, etc. In particular due to their barrier function and/or the release of ions, corrosion protection particles may assist with a corrosion protection effect. The content of inorganic particles is preferably low enough that no interfering friction occurs during forming. The content of inorganic particles is preferably high enough that the particles have a barrier function, and increased corrosion protection is achieved.

In individual embodiments, the composition according to the invention contains at least one accelerator, for example at least one accelerator selected from the group composed of accelerators based on chlorate, nitrite, nitrobenzene sulfonate, nitroguanidine, perborate, and at least one other nitroorganic compound having oxidizing properties, which are known from phosphating. These compounds may also assist in reducing or avoiding the formation of hydrogen gas at the interface with the metallic surface. In some embodiments, the aqueous composition contains at least one of these accelerators in the range of 0.05 to 30 g/L, particularly preferably in the range of 0.3 to 20, 1 to 12, 1.5 to 8, or 2 to 5 g/L.

The composition according to the invention preferably contains at least one additive, for example in each case at least one wetting agent, one demulsifier, one emulsifier, one defoaming agent, one corrosion inhibitor, and/or one UV absorber. If necessary, at least one further additive may be added, as is common and known in principle for conversion coatings, passivations, and lacquers/primers. The aqueous composition preferably contains at least one additive having an overall content of the additives in the range of 0.001 to 50 g/L, particularly preferably in the range of 0.01 to 30, 0.1 to 10, 0.5 to 6, or 1 to 3 g/L.

The object is achieved using an aqueous composition corresponding to the main claim.

The object is further achieved using a coating which is prepared using the method according to the invention and/or using an aqueous composition according to the invention.

The aqueous composition may vary over a wide range, and preferably contains
a) 1 to 250 g/L phosphate, calculated as PO₄, or 0.75 to 185 phosphate, calculated as P₂O₅,
b) 0.1 to 50 g/L of at least one titanium and/or zirconium compound, calculated as Ti metal,
c) 0.1 to 60 g/L of at least one complexing agent,
d) 0.5 to 80 g/L of cations of aluminum, chromium(III), and/or zinc and/or of at least one compound containing aluminum, chromium(III), and/or zinc, and
e) 1 to 500 g/L of at least one acid-tolerant cationic or nonionic organic polymer/copolymer, relative to the content of the solids and active substances.

The composition according to the invention preferably contains:
15 to 400 g/L organic polymers/copolymers e),
1 to 50 g/L or 0 g/L lubricant f),
1 to 50 g/L Al, Cr(III), and/or Zn d) combined,
2 to 200 g/L phosphate, as PO₄,
5 to 150 g/L phosphate, as P₂O₅,
1 to 40 g/L complexing agent c),
0.5 to 30 g/L Ti and/or Zr b) together, calculated as Ti metal, and optionally
1 to 50 or approximately 0 g/L F from at least one fluorine compound (Fₜₒₜₐₗ:), and/or
0.5 to 30 or approximately 0 g/L silicon compound(s), calculated as Si metal, and optionally
also at least one of the other compounds named in the present patent application.

The aqueous composition particularly preferably contains:
25 to 300 g/L organic polymers/copolymers e),
2 to 30 g/L or 0 g/L lubricant f),
2 to 30 g/L Al, Cr(III), and/or Zn d) combined,
3 to 120 g/L phosphate, as PO₄,
2.2 to 90 g/L phosphate, as P₂O₅,
2 to 18 g/L complexing agent c),
1 to 15 g/L Ti and/or Zr b) combined, calculated as Ti metal, and optionally
2 to 25 or approximately 0 g/L F from at least one fluorine compound (Fₜₒₜₐₗ), and/or
2 to 5 or approximately 0 g/L silicon compound(s), calculated as Si metal, and optionally
also at least one of the other compounds named in the present patent application.

These stated contents apply for concentrates as well as baths. For baths, all of the above information concerning ranges in each case may, for example, be divided by a dilution factor of 1, 2, or 4, for example.

The weight ratio of (Al, Cr³⁺, Fe, Mn, and Zn):(Ti and Zr) and/or of (Pd, Cr³⁺, and Zn):(Ti and Zr) is preferably in the range of 0.1:1 to 3:1. These weight ratios are particularly preferably in the range of 0.5:1 to 2, 5:1 or 1:1 to 2:1.

In addition to the added contents in particular of aluminum, chromium(III), Iron, manganese, titanium, zinc, and/or zirconium, these and optionally other cations may be contained in the composition according to the invention: on the one hand, by entrainment, for example from previous baths, from impurities, and/or by leaching out from tank and pipe materials and from the surfaces to be coated, and on the other hand by addition of further cations/compounds containing metal, for example at least one alkali metal, molybdenum, and/or vanadium.

In many embodiments, the aqueous composition according to the invention is preferably free or essentially free of compounds based on epoxy, phenol, starch, chromium(VI), and/or based on other heavy metals, for example those based on chromium, molybdenum, nickel, vanadium, and/or tungsten. In many embodiments, the aqueous composition according to the invention is preferably free or essentially free of compounds which are used as accelerators in phosphating, in particular compounds based on chlorate, nitrite, nitroguanidine, peroxide, and/or other N-containing accelerators.

The compositions according to the invention are preferably free or essentially free of chromium(VI). However, for some of the compositions according to the invention they may optionally also be free or essentially free of chromium(III), in particular optionally free or essentially free of cations and/or compounds of chromium.

The aqueous composition preferably contains no calcium and/or magnesium, or only a content of no more than 0.5 g/L, particularly preferably no more than 0.15 g/L, of calcium and/or magnesium, and/or no toxic or environmentally harmful heavy metal, or only a content of no more than 0.5 g/L, particularly preferably no more than 0.15 g/L, of at least one toxic or environmentally harmful heavy metal, for example chromium. In fluoride-free compositions, a certain, or higher, content of calcium and/or magnesium may also be present.

The composition according to the invention preferably has a pH approximately in the range of 0 to 10. The pH in particular is in the range of 1 to 8, 1.5 to 6, 2 to 5, 2.5 to 4, or 3 to 3.5. In this regard, a low pH is preferred in many embodiments in order to produce a high pickling effect and to transfer a high proportion of the pickled-out cations into the coating and/or in a coating beneath or in a polymer coating, so that the conversion effect is clearly maintained despite a high proportion of organic polymers/copolymers in the composition. On the other hand, it must be ensured that the content of pickled-out cations does not have a greater adverse effect on the corrosion protection.

In principle, in some embodiments having an increased content of at least one complexing agent, a pH of the composition may also be set in the range of 4 to approximately 10, hi that case an increased quantity of at least one approximately neutral and/or basic compound being added in each case. In particular ammonia, at least one other basic compound optionally containing nitrogen, for example at least one amine, at least one basic carbonate-, hydroxide-, and/or oxide-containing compound, at least one organic polymer/copolymer, and/or at least one silane/silanol/siloxane/polysiloxane may be added to influence the pH. For example, zinc oxide, manganese carbonate, and/or essentially neutral or basic polymers and/or copolymers may also be added. The content of approximately neutral and/or basic media, which assist in adjusting the pH and which are added mainly, or only, for adjusting the pH, may preferably be zero or in the range of 0.05 to 100 g/L, particularly preferably in the range of 0.2 to 60 g/L, 1 to 40 g/L, 2 to 25 g/L, 3 to 18 g/L, or 4 to 12 g/L. Due to content of fluoride and/or silane/polysiloxane, it may be advantageous not to carry out measurements with a glass electrode, but to use pH indicator paper instead.

All or most of the compounds which are also present in corresponding constituents in the solution are preferably added as additives to the aqueous concentrate for preparing an aqueous composition. The composition of the bath is preferably prepared from the aqueous concentrate by diluting the aqueous concentrate, together with 10 to 1000% of the solids and active substance content of the concentrate, with water. However, in some embodiments a highly concentrated and/or undiluted suspension or emulsion may also be advantageously used.

Surfaces of all metallic materials may be coated according to the invention, Metallic surfaces made of aluminum, iron, copper, magnesium, titanium, zinc, tin, and/or the alloys thereof are preferably coated, in particular zinc, steel, and hot dip-galvanized (HOG), electrolytically galvanized, Galvalume®, Galfan®, and/or Alusi® surfaces. The composition according to the invention has proven to be superior in particular for zinc-rich and/or aluminum-rich metallic surfaces. The metallic components which are coated using the method according to the invention may be used in particular in automotive manufacture, as architectural elements in construction, or for manufacture of equipment and machines, for example electrical equipment or household appliances. Mounting parts, strips, sheets, molded parts, cast parts, and small parts such as screws and profiles are particularly suited as metallic objects to be coated.

In particular a temperature of the aqueous composition of 10 to 40° C. is suitable during the coating. A temperature of the substrate of 10 to 40° C. is particularly suitable during the coating.

The coating which is produced according to the invention may have a coating composition which varies over a wide range. In particular, the coating may be characterized in that it contains:

| | |
|---|---|
| Organic polymer/copolymer | 50 to 15,000 mg/m² |
| Lubricant | 0, or 3 to 2000 mg/m² |
| Al, Cr, and/or Zn, calculated as metal | 1 to 400 mg/m² |
| Sum of Ti and/or Zr, calculated as Ti | 1 to 300 mg/m² |
| metal | |
| Phosphate, calculated as PO₄ | 4 to 1600 mg/m² |
| Phosphate, calculated as P₂O₅ | 3 to 1200 mg/m² |
| Si compound(s), calculated as Si metal | approx. 0, or 0.5 to 150 |
| | mg/m². |

The coating according to the invention particularly preferably contains:

| | |
|---|---|
| Organic polymer/copolymer | 250 to 8000 mg/m² |
| Lubricant | 0, or 10 to 1000 mg/m² |
| Al, Cr, and/or Zn, calculated as metal | 10 to 250 mg/m² |
| Sum of Ti and/or Zr, calculated as Ti | 10 to 180 mg/m² |
| metal | |
| Phosphate, calculated as PO₄ | 40 to 1100 mg/m² |
| Phosphate, calculated as P₂O₅ | 30 to 800 mg/m² |
| Si compound(s), calculated as Si metal | approx. 0, or 5 to 100 |
| | mg/m². |

These contents may be determined using an X-ray fluorescence analytical method on a trimmed coated sheet. In this regard, the weight ratio of (Al, Cr³⁺, and Zn):(Ti and Zr) of the coating composition may preferably be in the range of 0.5:1 to 1.8:1, particularly preferably in the range of 0.9:1 to 1.4:1.

The layer weight of the layer which is formed according to the invention may vary over a wide range. The layer weight may be in the range of 0.01 to 50 g/m², 0.05 to 30 g/m², 0.1 to 20 g/m², 0.3 to 12 g/m², 0.5 to 10 g/m², 0.8 to 8 g/m², 1 to 6 g/m², 1.2 to 5 g/m², 1.5 to 4 g/m², 1.8 to 3 g/m², or 2 to 2.5 g/m². For coating in strip facilities, the layer weight in particular may be in the range of 10 to 50,000 mg/m², preferably in the range of 500 to 20,000, particularly preferably in the range of 700 to/2,000 or 900 to 6000, very particularly preferably in the range of 1000 to 2000 mg/m². For coating in strip facilities, the overall content of titanium and/or zirconium in the dry film is preferably in the range of 1 to 100 mg/m², particularly preferably in the range of 10 to 60 mg/m², of Ti and/or Zr, calculated as Ti metal. The overall content of titanium and/or zirconium may be measured by X-ray fluorescence, for example. For coating in strip facilities, the overall content of silicon in the dry film is preferably in the range of 1 to 80 mg/m², particularly preferably in the range of 3 to 40 mg/m², of Si, calculated as metal. For coating in strip facilities, the overall content of P₂O₅ in the dry film is preferably in the range of 30 to 400 mg/m², particularly preferably in the range of 60 to 300 mg/m², of P₂O₅.

For coating in strip facilities, the thickness of the coatings according to the invention is often in the range of 0.01 to 40 μm, 0.1 to 20 μm, 0.3 to 15 μm, 0.5 to 10 μm, or 3 to 10 μm, in particular in the range of 0.5 to 6.5 μm, 0.8 to 4.5 μm, or 1 to 3 μm. For coating in facilities other than strip facilities, such as for coating of parts, the thickness of the coating is often in the range of 0.1 to 50 μm, 0.2 to 20 μm, or 0.3 to 15 μm, in particular in the range of 0.5 to 2 μm, 0.8 to 1.8 μm, or 1 to 1.5 μm.

The aqueous compositions according to the invention frequently have a concentration of the solids and active substances (overall concentration) in the range of 10 to 800 g/L. A concentrate may often have an overall concentration in the range of 200 to 800 g/L, in particular 400 to 750 g/L. Dilution with water may be performed, if necessary. A concentrate is preferably diluted by a factor in the range of 1.1 to 25, particularly preferably in the range of 1.5 to 16, 2 to 10, or 3 to 6. The content of solids and active substances to be set in the aqueous composition is primarily a function of the type of substrate to be coated, the particular facility, and the wet film thickness required by the facility.

In many embodiments, the composition according to the invention is used on a metallic strip (coil) in a strip coating process. Many of the strip facilities have a conveyor speed in the range of 10 to 200 m/min. The faster the strip is moved, the more rapidly the reactions between the composition according to the invention and the metallic surface must take place in order to avoid the need for excessively long facility sections. The reaction time between the application of the composition and the complete drying thereof may last from a fraction of a second to approximately 60 seconds. As a result, in particular for the faster strip facilities, the aqueous composition may have insufficient reactivity and must therefore have stronger acidity and greater pickling power. The pH of the aqueous composition is preferably in the range of 1.5 to 3.5 for strip coating processes. For coating in strip facilities, the concentration of all solids and active substances in the aqueous composition is often in the range of 200 to 800 or 300 to 650 g/L. The contents of individual components or additives are adjusted corresponding to the overall contents. The aqueous composition is usually applied to the clean or cleaned metallic strip by spraying and squeezing, or by dipping and squeezing in the form of a wet film which often has a wet film thickness in the range of 1 to 12 μm. For this purpose, a chemcoater or roll coater may instead be used for the application.

In many embodiment variants, the wet film is applied to metallic strips or sheets and dried (drying or no-rinse method). The drying may preferably take place in a temperature range from approximately room temperature to approximately 120° C. peak metal temperature (PMT), preferably in a temperature range of 50 to 100° C. or 70 to 100° C. The composition according to the invention may be specifically adjusted for a slow or rapid treatment in a strip facility, for example by means of a suitable concentration and suitable pH. Thus, neither the wet film nor the dried film is rinsed with water, so that the cations and compounds which are pickled out from the metallic surface are not removed, but instead are incorporated into the coating.

In the coating according to the invention of metallic parts, for example sheet metal sections, cast parts, moldings, and parts with complicated shapes, the reaction time from the first contacting of the composition to the complete drying thereof (no-rinse process), or to the flushing of components which are removable by rinsing with water (rinse process), is preferably 0.5 to 10 minutes. Longer times are possible in principle. The concentration of all solids and active substances in the aqueous composition is often in the range of 10 to 500 g/L or 30 to 300 g/L. In particular for rinsed coatings, it may sometimes be advisable to treat the coatings with a subsequent rinse solution, since much is often removed when rinsing with water. Instead of layer formation, as the result of contact with the composition according to the invention it is possible in some compositions that essentially only a pickling effect and/or only a very thin coating occurs, so that for hot dip-galvanized surfaces, for example, the zinc crystallization pattern is discernible at zinc grain boundaries.

Finding more than a single polymer/copolymer which did not precipitate in the compositions according to the invention when admixed, and which was stable for a fairly long period, i.e., an acid-tolerant polymer/copolymer, has been a complicated process. Therefore, it was surprising that one of these acid-tolerant polymers/copolymers so greatly changed and improved the property spectrum of the produced coatings (see FIGS. 1 and 2).

In DE 102008000600 A1 it was already surprising that the unmodified passivation coating, in contrast to a phosphate layer, provides an uncommonly high level of bare corrosion protection, even when the coating is optionally even thinner than a phosphate layer, and even when it is free of chromium. In comparison, the bare corrosion protection of the unmodified passivation coatings was often better than the comparable zinc phosphated coatings by a time factor of at least 20 or 30.

It was surprising that the high-quality properties of the compositions and coatings of DE 102008000600 A1 could now be drastically increased, as demonstrated by FIGS. 1 and 2 and the examples, and that the properties and the property spectrum could be so greatly improved that the fields of application for the substrates thus coated are significantly expanded.

It was surprising that the aqueous composition according to the invention is stable for such a long time that it may be sold as a single-component product, which is a great advantage over the unmodified passivations of DE 102008000600 A1. This is because it has been shown that in the composition according to the invention, it is not necessary to store an additive separately in order to be able to keep the product stable for a long time. Therefore, the composition according to the invention is much easier to handle than a dual-component product, in which at least one additive must be stored separately and mixed in just before onset of the unmodified passivation.

It was surprising that adding a cationic polyurethane resin to the composition according to the invention has resulted in such outstanding properties of the coatings thus produced.

It was surprising that the composition according to the invention is uncommonly stable, even with an average content of complexing agent and even with a very high content of solids and active substances.

It was surprising that a stable composition which is modified according to the invention allows the surface appearance of the substrate to remain discernible with practically no alteration. Thus, for example, the grain structure may be easily visible through the coating according to the invention.

The composition according to the invention and the method according to the invention may be used in particular:
as a passivating agent for passivation of the metallic surfaces, the passivation coatings often having layer thicknesses in the range of 0.03 to 8 μm or 0.3 to 5 μm,
as a pretreatment agent for pretreating prior to a subsequent coating, for example before an organic coating such as a lacquer, the pretreatment coating often having layer thicknesses in the range of 0.1 to 8 μm or 0.3 to 3 μm,
as a subsequent rinse composition for subsequent rinsing, for example for sealing, protecting, and/or for improving the properties of a prior coating, for example a conversion coating or a coating from anodizing, the subsequent rinse coatings often having layer thicknesses in the range of 0.03 to 5 μm or 0.3 to 2 μm,
for producing thin film coatings, which often have a layer thickness in the range of 0.1 to 5 μm or 0.6 to 2.5 μm, for example coatings for the permanent coating and/or for primers,
for producing thick film coatings, which often have a layer thickness in the range of 5 to 60 μm, 8 to 40 μm, or 12 to 25 μm, for example coatings for primers,
as a pretreatment primer for producing coatings without prior pretreatment with a conversion coating (pretreatment primer coatings), which often have a layer thickness in the range of 0.1 to 30 μm, 1 to 20 μm, or 3 to 12 μm,
for producing coatings on metallic coatings provided by electroplating and/or currentless means, which often have a layer thickness in the range of 0.1 to 20 μm or 0.5 to 12 μm, and
for coating metallic and/or nonmetallic surfaces, in particular for the simultaneous coating of metallic and nonmetallic surfaces, and/or for protecting metallic and/or nonmetallic surfaces.

The aqueous composition according to the invention may be used in particular as passivating agent, as pretreatment agent, as subsequent rinse composition, for producing thin film coatings, for producing thick film coatings, as primer, as pretreatment primer, and/or for coating metallic and/or nonmetallic surfaces.

The coating according to the invention may be used in particular as passivation coating, as pretreatment coating, as subsequent rinse coating, as thin film coating, as thick film coating, as pretreatment primer coating, and/or for protecting metallic and/or nonmetallic surfaces.

### EXAMPLES AND COMPARATIVE EXAMPLES

The examples (B) and comparative examples (VB) described below are provided to explain the subject matter of the invention in greater detail.

Aqueous compositions were mixed, the compositions of which are stated as concentrates in Table 1. The dilution factor explains the dilution of the concentrate to the bath concentration used, i.e., from a concentrate to a bath, so that for a concentrate, 200 g, for example, was used, and diluted with water to 1000 g, using a dilution factor of 5. The dilution factor “-” means that the stated composition was used without further dilution with water, as indicated in the table by its contents for this example, in other examples, dilution by a factor of up to of 2 was carried out, using deionized water. In contrast, the bath composition is stated in Table 2.

Manganese was added as manganese carbonate and/or manganese oxide, and zinc was added as monozinc phosphate and/or zinc oxide, 3-Aminopropyltriethoxysilane (APS) was added as silane 1. 1-Hydroxyethane-1,1-diphosphonic acid (HEDP) was used as complexing agent 1, and L-(+)-tartaric acid was used as complexing agent 2. The homogeneity and suitability of the application liquid were essentially influenced by the addition of complexing agent 2. An ammonium molybdate salt was added to inorganic blend 2 as corrosion inhibitor. Hexafluorotitanic acid, hexafiuorozirconic add, and/or dihydroxo-bis-(ammonium lactate)titanate was/were added as titanium and/or zirconium compound.

Starting with the aqueous inorganic composition of comparative example VB0 in Table 1, which is very well suited as passivating agent, various quantities and types of acid-tolerant polymers/copolymers together with wax and associated additives were added. These polymers/copolymers are very well suited for this purpose, since they are stable even at pH values in the range of 1.5 to 3 due to the fact that no precipitation occurred in the aqueous composition when these substances were mixed in, and the dispersions thus produced were stable for at least 4 weeks, usually for even longer than 4 months. Acid-tolerant nonionic and/or cationic resins were used as polymers/copolymers. A cationic polyurethane resin containing polycarbonate polyol as dispersion (minimum film formation temperature MFT approximately −5° C., elasticity at 100% approximately 13 MPa, elongation 230%) and a modified anionic acrylic resin (T_{g} approximately 35° C., MFT approximately 30° C., relatively hard due to a König pendulum hardness of 70-120 s) were used for the tests.

A wax emulsion based on cationically stabilized oxidized polyethylene and having a melting point of approximately 125° C. was used as lubricant.

A polysiloxane was used as wetting agent for improving the substrate wetting during the wet film application. A mixture of aliphatic hydrocarbons and SiO₂ was used as defoaming agent. At least one glycol, in particular a polyethylene glycol ether containing 10 C atoms, was added to further reduce the coefficient of friction of the coating according to the invention. The pH was adjusted, as necessary, using aqueous ammonia solution. The pH values in Table 1 apply for concentrates as well as bath concentrations. When the concentrates were diluted for preparing bath solutions, it was ensured that no precipitation occurred. The concentrates and bath solutions were stored at room temperature up to 24 hours before use.

### Examples B1-B18 According to the Invention and Comparative Example VB0

In each case, multiple sheets of hot dip-galvanized (HDG) steel and, in examples not explained in detail, sheets of cold-rolled steel (CRS), Galvalume® (AZ). Galfan® (IA), and Alusi® (AS) were also used and tested.

The sheets were precleaned with a cloth to largely remove adhering corrosion protection oil and to achieve a uniform distribution of the oil or other impurities. The sheets were then cleaned by spraying with mildly alkaline, silicate-free powdered cleaner until complete wettability with water was achieved. This generally took 20 to 30 s. This was followed by rinsing with tap water for 6 s for the dipping process, rinsing with tap water for 6 s for the spraying process, and rinsing with demineralized (OM) water for 6 s. The majority of the adhering water was then removed from the sheets by squeezing between two rubber rollers. The sheets were then blown dry using oil-free compressed air.

The dry sheets were brought into contact with the aqueous composition, at a temperature of approximately 25° C., using a laboratory roller coater. A wet film approximately 9 to 10 μm thick was applied. A dry film 0.2 to 0.6 μm thick was produced by drying this wet film at 70° C. PMT. For this purpose, the sheets treated in this manner were dried at approximately 40 or 65° C. PMT. Commercially available adhesive tape was then affixed to the edges of the coated sheets in order to exclude edge effects during the corrosion testing.

The coated sheets were then tested for bare corrosion protection in the condensation water constant humidity test (KK test, currently referred to as the OH (constant humidity) test) according to DIN EN ISO 6270-2, and in the neutral salt spray (NSS) test according to LAN EN ISO 9227. The evaluation was performed visually. The stated values for the corrosion refer to the percentage of surface area corresponding to the total surface area (100%) that is accessible to the chemical exposure.

The coefficient of friction was determined according to a company-specific method, in which the application of force required to laterally move two superposed coated sheets is measured.

The resistance to cleaners, coolants, ethanol, and deionized water was determined by saturating a cloth with the medium and performing defined rubbing under pressure, and in practical use is important over the estimated service life, based on the chemical resistance. In this regard, organic coatings may experience a loss in quality compared to inorganic coatings.

The antifingerprint properties were determined by immersion in a synthetic hand perspiration test solution according to BSH Test Standard LV 02 C, Section 6.2.2. Mar. 1, 2007. The results indicate that the chemicals left behind by fingerprints do not result in visible changes such as discoloration or signs of corrosion,

TABLE 1
Compositions of concentrates, dilution thereof, and properties of the produced dry films

| Content in g/L | VB0 | B1 | B2 | B3 | B4 | B5 | B6 | B7 | B8 |
|---|---|---|---|---|---|---|---|---|---|
| Organic:inorganic weight ratio | 0:1 | 0.242:1 | 0.242:1 | 0.242:1 | 0.529:1 | 0.529:1 | 0.962:1 | 0.962:1 | 1.45:1 |
| Polymer A (cationic PU) | | 55 | 55 | 55 | 80 | 80 | 110 | 110 | 135 |
| Polymer B (acid-tolerant acrylate) | | | | | | | | | |
| Wax | | 4.4 | 4.4 | 4.4 | 6.4 | 6.4 | 8.8 | 8.8 | 10.8 |
| Long-chain alcohol | | 1.6 | 1.6 | 1.6 | 2.3 | 2.3 | 3.2 | 3.2 | 3.9 |
| Wetting agent | | 0.5 | 0.5 | 0.5 | 0.7 | 0.7 | 0.9 | 0.9 | 1.2 |
| Defoaming agent | | 0.6 | 0.6 | 0.6 | 0.9 | 0.9 | 1.2 | 1.2 | 1.5 |
| Zn | 57.1 | 17.1 | 17.1 | 17.1 | 11.4 | 11.4 | 8.6 | 8.6 | 7.0 |
| PO₄ | 248.8 | 74.7 | 74.7 | 74.7 | 49.8 | 49.8 | 37.4 | 37.4 | 30.4 |
| P₂O₅ | 185.9 | 55.5 | 55.5 | 55.5 | 37.0 | 37.0 | 27.8 | 27.8 | 22.6 |
| H₂TiF₆ | 162.5 | 48.9 | 48.9 | 48.9 | 32.6 | 32.6 | 24.5 | 24.5 | 19.9 |
| Ti fraction, calculated as metal | 46.9 | 14.1 | 14.1 | 14.1 | 9.4 | 9.4 | 7.1 | 7.1 | 5.7 |
| Fₜₒₜₐₗ | 113 | 33.6 | 33.6 | 33.6 | 22.4 | 22.4 | 16.8 | 16.8 | 13.7 |
| Complexing agent 1 | 78 | 23.4 | 23.4 | 23.4 | 15.6 | 15.6 | 11.7 | 11.7 | 9.5 |
| Silane 1 | 78 | 23.4 | 23.4 | 23.4 | 15.6 | 15.6 | 11.7 | 11.7 | 9.5 |
| NH₃ | 45.6 | 13.5 | 13.5 | 13.5 | 9.0 | 9.0 | 6.8 | 6.8 | 5.5 |
| Dilution factor | 10 | 5 | 2 | 1.5 | 5 | 2 | 5 | 2 | 5 |
| pH | 1.9 | 2.3 | 2.3 | 2.3 | 2.5 | 2.5 | 2.6 | 2.6 | 2.7 |
| Layer weight, mg/m² | 400 | 320 | 800 | 1200 | 320 | 800 | 320 | 800 | 320 |
| Ti support, mg/m² | 34 | 20 | 50 | 67 | 13 | 33 | 10 | 25 | 8 |
| P₂O₅ support, mg/m² | 170 | 101 | 253 | 393 | 67 | 169 | 50 | 126 | 41 |

| Dry film properties | VB0 | B1 | B2 | B3 | B4 | B5 | B6 | B7 | B8 |
|---|---|---|---|---|---|---|---|---|---|
| Substrate | HDG | HDG | HDG | HDG | HDG | HDG | HDG | HDG | HDG |
| % surface corrosion after 120 h CH test | 0 | 5 | 0 | 0 | 0 | 0 | 0 | 0 | 5 |
| % surface corrosion after 480 h CH test | 0 | 50 | 0 | 0 | 0 | 0 | 0 | 0 | 30 |
| % surface corrosion after 72 h salt spray test | 10 | 30 | 5 | 0 | 30 | 5 | 30 | 5 | 30 |
| % surface corrosion after 120 h salt spray test | 60 | 60 | 30 | 20 | 50 | 20 | 60 | 15 | 50 |
| % surface corrosion after 240 h salt spray test | 100 | 100 | 80 | 60 | 80 | 40 | 80 | 30 | 80 |
| % surface corrosion after 2 wk wet stack test | 20 | 40 | 5 | 5 | 20 | 5 | 20 | 5 | 30 |
| Coefficient of friction | >0.4 | 0.25 | 0.25 | 0.25 | 0.21 | 0.21 | 0.16 | 0.16 | 0.16 |
| Antifingerprint behavior | | | 0 | 0 | 0 | + | 0 | + | |
| Resistance to cleaners at pH 10.5 | | | | | | | | 0 | |
| Dry film properties | VB0a | B1a | B2a | B3a | B4a | B5a | B6a | B7a | B8a |
| Substrate | ZE | ZE | ZE | ZE | ZE | ZE | ZE | ZE | ZE |
| % surface corrosion after 120 h CH test | 0 | 10 | 0 | 0 | 0 | 0 | 0 | 0 | 10 |
| % surface corrosion after 240 h CH test | 0 | 30 | 0 | 0 | 0 | 0 | 0 | 0 | 40 |
| % surface corrosion after 48 h salt spray test | 10 | 30 | 5 | 0 | 30 | 5 | 30 | 5 | 20 |
| % surface corrosion after 120 h salt spray test | 100 | 100 | 80 | 60 | 80 | 40 | 80 | 30 | 100 |
| % surface corrosion after 2 wk wet stack test | 20 | 40 | 5 | 5 | 20 | 5 | 20 | 5 | 20 |
| Coefficient of friction | >0.4 | 0.25 | 0.25 | 0.25 | 0.21 | 0.21 | 0.16 | 0.16 | >0.4 |
| Antifingerprint behavior | | | 0 | 0 | 0 | + | 0 | + | |
| Resistance to cleaners at pH 10.5 | | | | | | | | 0 | |

| Content in g/L | B9 | B10 | B11 | B12 | B13 | B14 | B15 | B16 | B17 | B18 |
|---|---|---|---|---|---|---|---|---|---|---|
| Organic:inorganic weight ratio | 1.45:1 | 2.17:1 | 2.17:1 | 2.17:1 | 2.94:1 | 5.56:1 | 2.17:1 | 2.17:1 | 2.17:1 | 2.17:1 |
| Polymer A (cationic PU) | 135 | 165 | 165 | 165 | 190 | 250 | 130 | 110 | 95 | 85 |
| Polymer B (acid-tolerant acrylate) | | | | | | | 35 | 55 | 70 | 80 |
| Wax | 10.8 | 13.2 | 13.2 | 13.2 | 15.2 | 20 | 13.2 | 13.2 | 13.2 | 13.2 |
| Long-chain alcohol | 3.9 | 4.8 | 4.8 | 4.8 | 5.5 | 7.2 | 4.8 | 4.8 | 4.8 | 4.8 |
| Wetting agent | 1.2 | 1.5 | 1.5 | 1.5 | 1.7 | 2.3 | 1.5 | 1.5 | 1.5 | 1.5 |
| Defoaming agent | 1.5 | 1.8 | 1.8 | 1.8 | 2.1 | 2.7 | 1.8 | 1.8 | 1.8 | 1.8 |
| Zn | 7.0 | 5.7 | 5.7 | 5.7 | 4.8 | 3.4 | 5.7 | 5.7 | 5.7 | 5.7 |
| PO₄ | 30.4 | 24.9 | 24.9 | 24.9 | 21.2 | 14.9 | 24.9 | 24.9 | 24.9 | 24.9 |
| P₂O₅ | 22.6 | 18.5 | 18.5 | 18.5 | 15.7 | 11.1 | 18.5 | 18.5 | 18.5 | 18.5 |
| H₂TiF₆ | 19.9 | 16.3 | 16.3 | 16.3 | 13.9 | 9.8 | 16.3 | 16.3 | 16.3 | 16.3 |
| Ti fraction, calculated as metal | 5.7 | 4.7 | 4.7 | 4.7 | 4.0 | 2.8 | 4.7 | 4.7 | 4.7 | 4.7 |
| Fₜₒₜₐₗ | 13.7 | 11.2 | 11.2 | 11.2 | 9.5 | 6.7 | 11.2 | 11.2 | 11.2 | 11.2 |
| Complexing agent 1 | 9.5 | 7.8 | 7.8 | 7.8 | 6.6 | 4.7 | 7.8 | 7.8 | 7.8 | 7.8 |
| Silane 1 | 9.5 | 7.8 | 7.8 | 7.8 | 6.6 | 4.7 | 7.8 | 7.8 | 7.8 | 7.8 |
| NH₃ | 5.5 | 4.5 | 4.5 | 4.5 | 3.8 | 2.7 | 4.5 | 4.5 | 4.5 | 4.5 |
| Dilution factor | 2 | 2 | 1.5 | 0 | 0 | 0 | 0 | 0 | 0 | 0 |
| pH | 2.7 | 2.8 | 2.8 | 2.8 | 2.8 | 2.8 | 2.8 | 2.8 | 2.8 | 2.8 |
| Layer weight, mg/m² | 800 | 800 | 1200 | 1600 | 1600 | 1600 | 1600 | 1600 | 1600 | 1600 |
| Ti support, mg/m² | 18 | 16 | 24 | 32 | 27 | 19 | 32 | 32 | 32 | 32 |
| P₂O₅ support, mg/m² | 103 | 75 | 112.5 | 150 | 126 | 89 | 150 | 150 | 150 | 150 |

| Dry film properties | B9 | B10 | B11 | B12 | B13 | B14 | B15 | B16 | B17 | B18 |
|---|---|---|---|---|---|---|---|---|---|---|
| Substrate | HDG | HDG | HDG | HDG | HDG | HDG | HDG | HDG | HDG | HDG |
| % surface corrosion after 120 h CH test | 0 | 0 | 0 | 0 | 0 | 0 | 0 | 0 | 0 | 0 |
| % surface corrosion after 480 h CH test | 20 | 0 | 0 | 0 | 0 | 20 | 0 | 0 | 0 | 0 |
| % surface corrosion after 72 h salt spray test | 5 | 0 | 0 | 0 | 5 | 20 | 0 | 0 | 0 | 0 |
| % surface corrosion after 120 h salt spray test | 20 | 10 | 5 | 2 | 20 | 30 | 2 | 2 | 2 | 10 |
| % surface corrosion after 240 h salt spray test | 40 | 20 | 5 | 5 | 30 | 50 | 5 | 5 | 5 | 20 |
| % surface corrosion after 2 wk wet stack test | 20 | 5 | 0 | 0 | 0 | 10 | 0 | 0 | 0 | 5 |
| Coefficient of friction | 0.16 | 0.16 | 0.16 | 0.16 | 0.16 | 0.16 | 0.16 | 0.16 | 0.16 | 0.16 |
| Antifingerprint behavior | 0 | ++ | ++ | ++ | + | + | ++ | ++ | ++ | + |
| Resistance to cleaners at pH 10.5 | | ++ | ++ | ++ | + | + | ++ | ++ | + | + |
| Dry film properties | B9a | B10a | B11a | B12a | B13a | B14a | B15a | B16a | B17a | B18a |
| Substrate | ZE | ZE | ZE | ZE | ZE | ZE | ZE | ZE | ZE | ZE |
| % surface corrosion after 120 h CH test | 5 | 5 | 0 | 0 | 0 | 0 | 0 | 0 | 0 | 0 |
| % surface corrosion after 240 h CH test | 20 | 20 | 5 | 0 | 0 | 10 | 0 | 0 | 0 | 5 |
| % surface corrosion after 48 h salt spray test | 10 | 10 | 5 | 0 | 0 | 10 | 0 | 5 | 0 | 5 |
| % surface corrosion after 120 h salt spray test | 60 | 60 | 30 | 10 | 10 | 50 | 10 | 15 | 20 | 30 |
| % surface corrosion after 2 wk wet stack test | 10 | 5 | 0 | 0 | 0 | 20 | 0 | 5 | 5 | 10 |
| Coefficient of friction | 0.25 | 0.25 | 0.25 | 0.21 | 0.21 | 0.16 | 0.16 | 0.16 | 0.16 | 0.18 |
| Antifingerprint behavior | 0 | 0 | + | ++ | ++ | ++ | ++ | ++ | ++ | + |
| Resistance to cleaners at pH 10.5 | | ++ | ++ | ++ | ++ | + | ++ | ++ | + | + |

Regarding the examples and comparative example of Table 1:

In Examples B2 to B4 according to the invention, a concentrate was undiluted, or diluted with water by a factor of 1, 5 or 2, and then brought into contact with the hot dip-galvanized (HD) steel sheets. The different layer weights and other layer properties indicate that the corrosion resistance and other properties are a function of the layer thickness.

In Examples B5 to B7 according to the invention, the content of cationic polyurethane resin was continuously increased at a low rate. For the additives of cationic polyurethane resin having a low content compared to the inorganic components, the results showed significant differences in the layer properties, as also indicated in FIGS. 1 and 2.

Starting from Examples B5 to B7 according to the invention, the content of cationic polyurethane resin was further increased for Examples B11 and B12 according to the invention. In Examples B8 to B10 according to the invention, the concentration of the bath was varied by appropriate dilution. In Examples B9, B10, B11, B13, and B14 according to the invention, all of the stringent customer requirements were met.

Examples B13 to B16 according to the invention additionally have a varied content of acid-tolerant acrylate having a low styrene fraction, which as a modified anionic dispersion is latently cationic, which was replaced with a smaller fraction of cationic polyurethane dispersion. The properties of the coating showed slight impairment only after this acrylate was added in increased amounts.

In tests which are not discussed herein, it was also determined that the “inorganic” as well as the “organic” fraction may be varied chemically and from the process conditions over a wide range in order to produce superior coatings.

Regarding the examples and comparative examples of Table 2:

Unless stated otherwise, the same procedures were followed for the examples and comparative examples for Table 2 as for Table 1.

Acid-tolerant nonionic and/or cationic resins were used as polymers/copolymers. A cationic polyurethane resin containing polycarbonate polyol (MFT approximately −5° C., elasticity at 100% approximately 13 MPa, elongation 230%) as well as a modified anionic acrylic resin (T₉ approximately 35° C., MFT approximately 30° C., relatively hard due to König pendulum hardness of 70-120 s) were used for the tests. Their weight ratio is indicated as “Urethane: acrylate polymer ratio.” L-(+)tartaric acid (hydroxycarboxylic add) was used as complexing agent 2, in particular for optimizing the homogeneity and stability of the preparation over a fairly long storage period and subsequent application. The stability of the compositions was insufficient without adding hydroxycarboxylic add, since phase separation and agglomerate formation easily occurred. Such compositions were not usable (comparative examples VB39 VB41).

An “inorganic” fraction is understood to mean the inorganic composition based on patent application DE 102008000600 A1 (inorganic blend 1), or based on a very similar composition. Therefore, a distinction is made between inorganic blend 1 and inorganic blend 2, Inorganic blend 1 is optimized specifically for use on hot dip-galvanized metallic surfaces, and contains compounds based on monozinc phosphate, hexafluorotitanic add, complexing agent 1, aminosilane, and ammonium. Inorganic blend 2 has a content of compounds based on monozinc phosphate, hexafluorotitanic add, complexing agent 1, molybdate, aluminum, manganese, nitrate, and ammonium in similar quantities as for inorganic blend 1. In inorganic blend 3 the hexafluorotitanic add in the inorganic composition of inorganic blend 1 was replaced by hexafluorozirconic acid.

An “organic” fraction is understood to mean the organic composition containing at least one polymer/copolymer, wax, and associated additives.

In comparative examples VB20/1 and VB20/2, inorganic acidic passivating agent was incorporated in unmodified form as inorganic fraction, without an organic additive being admixed.

Hot dip-galvanized (HDG) sheets and electrolytically galvanized (ZE) sheets were used as substrates for Examples B21-B47 according to the invention and for the associated comparative examples.

The sheets were first subjected to cleaning with the alkaline cleaner Gardoclean® 5080 from Chemetall GmbH, in a concentration of 25 g/Lu at pH 10 and 60° C., sprayed at 1 bar over a period of 20 s.

The cleaned sheets were rinsed, first with tap water and then with completely demineralized water. The adherent water was dried at 100° C. over a period of approximately 2 minutes until the water was completely evaporated.

The composition according to the invention was applied to the cleaned sheets using a No. 3 spiral applicator, forming a wet film having a layer weight of frequently approximately 6 g/m². The mixture of inorganic and organic fractions according to the invention was used to simultaneously form a conversion layer and a predominantly organic layer, which apparently was only gradually coordinated with the conversion layer.

The desired dry layer thickness was set by adjusting the concentration of the liquid composition, and thus, by adjusting the dry residue. The dry layer thickness was set, for example, at 20% by weight for approximately 1000 mg/m² dry film for Examples B21-B41, and at 10% by weight for approximately 500 mg/m² dry film for Examples B42-B43.

The corrosion protection was tested without a lacquer layer, on the one hand in the salt spray test according to DIN EN ISO 2997, and on the other hand in the condensation water constant humidity test (referred to as the CH test formerly, KK test) according to DIN EN ISO 6270-2 H. In the salt spray test the percentage of surface corrosion was determined after 72 h, 120 h, and 240 h. In the CH test the percentage of surface corrosion was determined after 120 h, 240 h, and 480 h in the condensation water constant humidity test according to DIN EN ISO 6270-2 CH.

The formability of bodies coated according to the invention, such as sheets, for example, is of great importance for many applications. During forming, cracks must not appear, and corrosion must not occur, in extremely thin dry film often having a thickness of 0.4 to 2 μm. The formability of the coated moldings was tested in three variants:

1. Cupping test using the Erichsen test apparatus, Erichsen Model 142-20, with a hold-down pressure of 2500 kp,
2. Cupping test under these conditions, followed by a 24-h salt spray test according to DIN EN ISO 9227,
3. Cupping test under these conditions, followed by a 120-h condensation water constant humidity test according to DIN EN ISO 6270-2 CH.

Examples B21 to B30 showed excellent formability. None of the other examples was extensively tested, since the properties of the dry film were less satisfactory.

The lacquer adhesion was tested in the cross cutting test according to DIN EN ISO 2409 at a cutting distance of 1 mm, and in the conical mandrel bend test according to DIN EN ISO 6860. In the coin test, a coin was pulled with uniform pressure transverse to the direction of motion and approximately perpendicular to the coated substrate, the aim being for a uniform convex curvature to result without chipping. This is not a standardized test, but in practice is very meaningful.

The overcoatability of bodies according to the invention, such as sheets, for example, is likewise very important for many applications. Unformed bodies as well as formed coated bodies may be coated over. For a urethane-rich composition the overcoatability proved to be very good, whereas for an acrylate-rich composition the overcoatability was often poor. Examples B21 to B30 showed excellent overcoatability. None of the other examples was extensively tested, since the properties of the dry film were less satisfactory.

The resulting dry film thickness in the examples applied to electrolytically galvanized substrate surfaces under the same conditions was slightly greater than for hot dip-galvanized steel due to the higher surface roughness of the metal-plated substrates.

The resistance to cleaners was determined using the liquid alkaline cleaner Gardocleae® S 5102 from Chemetall GmbH, in a concentration of 25 g/L at pH 10 and 65° C. over a period of 20 s, and ascertaining the weight difference before, compared to after, cleaning.

TABLE 2
Compositions of the bath and properties of the produced dry films

| Content in g/L | VB20/1 | VB20/2 | B21 | B22 | B23 | B24 | B25 | B26 | B27 | B28 |
|---|---|---|---|---|---|---|---|---|---|---|
| Urethane:acrylate polymer | — | — | 100% acrylate | | | 1:3 | | | 1:1 | |
| ratio | | | | | | | | | | |
| Organic:inorganic ratio | — | — | 1.57 | 2.19 | 2.70 | 1.57 | 2.10 | 2.70 | 1.57 | 2.19 |
| DM water | 944.0 | 944.0 | 800.0 | 800.0 | 800.0 | 800.0 | 800.0 | 800.0 | 800.0 | 800.0 |
| Polymer A (cationic PU) | | | | | | 26.8 | 30.3 | 32.9 | 53.4 | 60.9 |
| Polymer B (acid-tolerant AC) | | | 106.8 | 121.8 | 130.5 | 79.9 | 91.5 | 97.5 | 53.3 | 60.9 |
| Oxidized polyethylene | | | 9.0 | 9.0 | 9.0 | 9.0 | 9.0 | 9.0 | 9.0 | 9.0 |
| Long-chain alcohol | | | 2.8 | 2.8 | 2.8 | 2.8 | 2.8 | 2.8 | 2.8 | 2.8 |
| Wetting agent | | | 0.8 | 0.8 | 0.8 | 0.8 | 0.8 | 0.8 | 0.8 | 0.8 |
| Defoaming agent | | | 1.1 | 1.1 | 1.1 | 1.1 | 1.1 | 1.1 | 1.1 | 1.1 |
| Completing agent 2 | | | 1.7 | 1.7 | 1.7 | 1.7 | 1.7 | 1.7 | 1.7 | 1.7 |
| Inorganic blend 1 | 56.0 | | 77.8 | 62.7 | 54.1 | 77.8 | 62.7 | 54.1 | 77.8 | 62.7 |
| Inorganic blend 2 | | 56.0 | | | | | | | | |
| pH | 2.0-2.5 | 2.0-2.5 | 2.0-2.5 | 2.0-2.5 | 2.0-2.5 | 2.0-2.5 | 2.0-2.5 | 2.0-2.5 | 2.0-2.5 | 2.0-2.5 |
| Application liquid | homogen. | homogen. | homogen. | homogen. | homogen. | homogen. | homogen. | homogen. | homogen. | homogen. |

| HDG substrate | VB20/1 | VB20/2 | B21 | B22 | B23 | B24 | B25 | B26 | B27 | B28 |
|---|---|---|---|---|---|---|---|---|---|---|
| Ti support, mg/m² | 24 | 24 | 30 | 24 | 20 | 30 | 24 | 20 | 30 | 24 |
| Dry film support, mg/m² | n.d. | n.d. | 1080 | 1080 | 1040 | 1080 | 1080 | 1040 | 1080 | 1080 |
| Ti:dry substance ratio | 12.5 | 14.6 | 36 | 45 | 52 | 36 | 45 | 52 | 36 | 45 |
| Overcoatability | | | | | | | | | | |

| ZE substrate | VB20/1a | VB20/2a | B21a | B22a | B23a | B24a | B25a | B26a | B27a | B28a |
|---|---|---|---|---|---|---|---|---|---|---|
| Ti support, mg/m² | 29 | 24 | 38 | 29 | 25 | 38 | 29 | 25 | 36 | 29 |
| Dry film support, mg/m² | n.d. | n.d. | 1296 | 1305 | 1300 | 1296 | 1305 | 1300 | 1296 | 1305 |
| Ti:dry substance ratio | 12.5 | 14.8 | 38 | 45 | 52 | 38 | 45 | 52 | 38 | 45 |
| Dry film properties | VB20/1 | VB20/2 | B21 | B22 | B23 | B24 | B25 | B26 | B27 | B28 |

| | | | | | | | | | | |
|---|---|---|---|---|---|---|---|---|---|---|
| HDG substrate | VB20/1a | VB20/2a | B21a | B22a | B23a | B24a | B25a | B26a | B27a | B28a |

Corrosion in the salt spray test:

| | | | | | | | | | | |
|---|---|---|---|---|---|---|---|---|---|---|
| % surface corrosion after 48 h | 2 | 5 | 2 | 2 | 0 | 0 | 0 | 0 | 0 | 0 |
| % surface corrosion after 96 h | 5 | 80 | 5 | 5 | 5 | 2 | 2 | 2 | 0 | 0 |
| % surface corrosion after 168 h | 10 | 100 | 10 | 20 | 20 | 10 | 5 | 5 | 0 | 0 |

Corrosion in the CH test:

| | | | | | | | | | | |
|---|---|---|---|---|---|---|---|---|---|---|
| Surface corrosion after 504 h | 5 | 20 | 0 | 0 | 0 | 0 | 0 | 0 | 0 | 0 |

Resistance to cleaner, 65° C., 120 s:

| | | | | | | | | | | |
|---|---|---|---|---|---|---|---|---|---|---|
| % by weight dry film removal | 60 | 70 | 20 | 20 | 20 | 15 | 15 | 15 | 10 | 10 |

Formability in cupping test, 2.5 t:

| | | | | | | | | | | |
|---|---|---|---|---|---|---|---|---|---|---|
| Cupping test | not poss. | not poss. | OK | OK | OK | OK | OK | OK | OK | OK |

Above +24 h salt spray test:

| | | | | | | | | | | |
|---|---|---|---|---|---|---|---|---|---|---|
| % surface corrosion after 24 h | 50 | 100 | 0 | 0 | 0 | 0 | 0 | 0 | 0 | 0 |

Above +120 h CH test:

| % surface corrosion after 120 h | 60 | 70 | 0 | 0 | 0 | 0 | 0 | 0 | 0 | 0 |
|---|---|---|---|---|---|---|---|---|---|---|
| Dry film properties | VB20/1a | VB20/2a | B21a | B22a | B23a | B24a | B25a | B26a | B27a | B28a |
| Substrate | HDG | HDG | HDG | HDG | HDG | HDG | HDG | HDG | HDG | HDG |

Lacquer adhesion without cleaning dry film coated with epoxy-polyester powder lacquer:

| | | | | | | | | | |
|---|---|---|---|---|---|---|---|---|---|
| Cross cutting according to | GT 1 | GT 4 | GT 4 | GT 4 | GT 2 | GT 2 | GT 2 | GT 2 | GT 2 |
| DIN EN ISO 2409, 1 mm | | | | | | | | | |
| Conical mandrel bend test acc. | <4 | >20 | >20 | >20 | >20 | >20 | >20 | >20 | >20 |
| to DIN EN ISO 6860 [mm] | | | | | | | | | |
| Coin test | ++ | −− | −− | −− | −− | −− | −− | −− | −− |

Lacquer adhesion after cleaning the dry film and subsequently coating with epoxy-polyester powder lacquer:

| Cross cutting according to | GT 1 | | GT 4 | GT 4 | GT 4 | GT 2 | GT 2 | GT 2 | GT 2 | GT 2 |
|---|---|---|---|---|---|---|---|---|---|---|
| DIN EN ISO 2409, 1 mm | | | | | | | | | | |
| Conical mandrel bend test acc. | <4 | | >20 | >20 | >20 | >20 | >20 | >20 | >20 | >20 |
| to DIN EN ISO 6860 [mm] | | | | | | | | | | |
| Coin test | ++ | | −− | −− | −− | −− | −− | −− | −− | −− |
| Dry film properties | VB20/1a | VB20/2a | B21a | B22a | B23a | B24a | B25a | B26a | B27a | B28a |
| Substrate | ZE | ZE | ZE | ZE | ZE | ZE | ZE | ZE | ZE | ZE |

Corrosion in the salt spray test:

| | | | | | | | | | | |
|---|---|---|---|---|---|---|---|---|---|---|
| % surface corrosion after 48 h | 60 | 80 | 0 | 5 | 5 | 0 | 2 | 2 | 0 | 2 |
| % surface corrosion after 72 h | 70 | 100 | 2 | 10 | 20 | 5 | 10 | 10 | 2 | 5 |
| % surface corrosion after 120 h | 90 | 100 | 40 | 60 | 60 | 10 | 30 | 30 | 5 | 20 |

| Content in g/L | B29 | B30 | B31 | B32 | B33 | B34 | B35 | B36 | B37 | B38 |
|---|---|---|---|---|---|---|---|---|---|---|
| Urethane:acrylate polymer | 1:1 | 100% | 1:1 | | | 100% AC | | | 1:1 | |
| ratio | | PU | | | | | | | | |
| Organic:inorganic ratio | 2.70 | 2.70 | 1.57 | 2.19 | 2.70 | 1.57 | 2.19 | 2.70 | 1.57 | 2.70 |
| DM water | 800.0 | 800.0 | 800.0 | 800.0 | 800.0 | 800.0 | 800.0 | 800.0 | 800.0 | 800.0 |
| Polymer A (cationic PU) | 65.2 | 130.4 | 53.4 | 60.9 | 65.2 | | | | 53.4 | 65.2 |
| Polymer B (acid-tolerant | 65.2 | | 53.3 | 60.9 | 65.2 | 106.8 | 121.8 | 130.5 | 53.3 | 65.2 |
| AC) | | | | | | | | | | |
| Oxidized polyethylene | 9.0 | 9.0 | 9.0 | 9.0 | 9.0 | 9.0 | 9.0 | 9.0 | 9.0 | 9.0 |
| Long-chain alcohol | 2.8 | 2.8 | 2.8 | 2.8 | 2.8 | 2.8 | 2.8 | 2.8 | 2.8 | 2.8 |
| Wetting agent | 0.8 | 0.8 | 0.8 | 0.8 | 0.8 | 0.8 | 0.8 | 0.8 | 0.8 | 0.8 |
| Defoaming agent | 1.1 | 1.1 | 1.1 | 1.1 | 1.1 | 1.1 | 1.1 | 1.1 | 1.1 | 1.1 |
| Complexing agent 2 | 1.7 | 1.7 | 1.7 | 1.7 | 1.7 | 1.7 | 1.7 | 1.7 | 1.7 | 1.7 |
| Inorganic blend 1 | 54.1 | 54.1 | | | | | | | 38.9 | 27.1 |
| Inorganic blend 2 | | | 77.8 | 62.7 | 54.1 | 77.8 | 62.7 | 54.1 | 38.9 | 27.0 |
| pH | 2.0-2.5 | 2.0-2.5 | 2.0-2.5 | 2.0-2.5 | 2.0-2.5 | 2.0-2.5 | 2.0-2.5 | 2.9-2.5 | 2.0-2.5 | 2.0-2.5 |
| Application liquid | homog- | homog- | homog- | homog- | homog- | homog- | homog- | homog- | homog- | homog- |
| | en. | en. | en. | en. | en. | en. | en. | en | en | en |
| HDG substrate | B29 | B30 | B31 | B32 | B33 | B34 | B35 | B36 | B37 | B38 |
| Ti support, mg/m² | 20 | 20 | 30 | 24 | 20 | 30 | 24 | 20 | 30 | 20 |
| Dry film support, mg/m² | 1040 | 1040 | 1080 | 1080 | 1040 | 1080 | 1080 | 1040 | 1080 | 1040 |
| Ti:dry substance ratio | 52 | 52 | 36 | 45 | 52 | 36 | 45 | 52 | 36 | 52 |
| Overcoatability | | | | | | | | | | |
| ZE substrate | B29a | B30a | B31a | B32a | B33a | B34a | B35a | B36a | B37a | B38a |
| Ti support, mg/m² | 25 | 25 | 36 | 29 | 25 | 30 | 24 | 20 | 30 | 20 |
| Dry film support, mg/m² | 1300 | 1300 | 1296 | 1305 | 1300 | 1080 | 1080 | 1040 | 1080 | 1040 |
| Ti:dry substance ratio | 52 | 52 | 36 | 45 | 52 | 36 | 45 | 52 | 36 | 52 |

| Dry film properties | B29a | B30a | B31a | B32a | B33a | B34a | B35a | B36a | B37a | B38a |
|---|---|---|---|---|---|---|---|---|---|---|
| Substrate | HDG | HDG | HDG | HDG | HDG | HDG | HDG | HDG | HDG | HDG |

Corrosion in the salt spray test:

| | | | | | | | | | | |
|---|---|---|---|---|---|---|---|---|---|---|
| % surface corrosion after 48 h | 2 | 0 | 5 | 5 | 5 | 5 | 5 | 5 | 0 | 0 |
| % surface corrosion after 96 h | 5 | 0 | 20 | 10 | 10 | 80 | 60 | 30 | 2 | 2 |
| % surface corrosion after 168 h | 10 | 0 | 80 | 40 | 30 | 100 | 100 | 80 | 5 | 5 |

Corrosion in the CH test:

| | | | | | | | | | | |
|---|---|---|---|---|---|---|---|---|---|---|
| Surface corrosion after 504 h | 0 | 0 | 2 | 2 | 2 | 5 | 5 | 5 | 0 | 0 |

Resistance to cleaner, 65° C., 120 s:

| | | |
|---|---|---|
| % by weight dry film removal | 60 | 10 |

Formability in cupping test, 2.5 t:

| | | |
|---|---|---|
| Cupping test | OK | OK |

Above +24 h salt spray test:

| | | |
|---|---|---|
| % surface corrosion after 24 h | 0 | 0 |

Above +120 h CH test:

| | | |
|---|---|---|
| % surface corrosion after 120 h | 0 | 0 |

Lacquer adhesion without cleaning dry film: coated with epoxy-polyester powder lacquer:

| | | |
|---|---|---|
| Cross cutting according to | GT 2 | GT1 |
| DIN EN ISO 2409, 1 mm | | |
| Conical mandrel bend test acc. | >20 | <4 |
| to DIN EN ISO 6860 [mm] | | |
| Coin test | −− | ++ |

Lacquer adhesion after cleaning the dry film and subsequently coating with epoxy-polyester powder lacquer:

| | | |
|---|---|---|
| Cross cutting according to | GT 2 | GT 1 |
| DIN EN ISO2409, 1 mm | | |
| Conical mandrel bend test [mm] | >20 | <4 |
| Coin test | — | ++ |

| Dry film properties | B29a | B30a | B31a | B32a | B33a | B34a | B35a | B36a | B37a | B38a |
|---|---|---|---|---|---|---|---|---|---|---|
| Substrate | ZE | ZE | ZE | ZE | ZE | ZE | ZE | ZE | ZE | ZE |
| Corrosion in the salt spray test: | 2 | 0 | 0 | 25 | 20 | 5 | 5 | 5 | 0 | 0 |
| % surface corrosion after 48 h | 5 | 2 | 10 | 30 | 60 | 30 | 70 | 80 | 2 | 40 |
| % surface corrosion after 72 h | 30 | 30 | 20 | 40 | 100 | 50 | 100 | 100 | 5 | 60 |

| Content in g/L | VB39 | VB40 | VB41 | B42 | B43 | B44 | B45 | B46 | B47 |
|---|---|---|---|---|---|---|---|---|---|
| Urethane:acrylate polymer ratio | 100% AC | 100% PU | 1:1 | 100% AC | 100% PU | 100% AC | 100% PU | 100% AC | 100% PU |
| Organic:inorganic ratio | 2.19 | 2.70 | 2.19 | 2.70 | 2.70 | 2.70 | 2.70 | 2.70 | 2.70 |
| DM water | 800.0 | 800.0 | 800.0 | 900.0 | 900.0 | 800.0 | 800.0 | 800.0 | 800.0 |
| Polymer A (cationic PU) | — | 130.4 | 60.9 | — | 62.3 | — | 130.4 | — | 125.4 |
| Polymer B (acid-tolerant AC) | 121.8 | — | 60.9 | 62.3 | — | 130.5 | — | 125.5 | — |
| Crosslinker (polyfunctional | — | — | — | — | — | — | — | 5.0 | 5.0 |
| aziridine) | | | | | | | | | |
| Oxidized polyethylene | 9.0 | 9.0 | 9.0 | 4.5 | 4.5 | 9.0 | 9.0 | 9.0 | 9.0 |
| Long-chain alcohol | 2.8 | 2.8 | 2.8 | 1.4 | 1.4 | 2.8 | 2.8 | 2.8 | 2.8 |
| Wetting agent | 0.8 | 0.8 | 0.8 | 0.4 | 0.4 | 0.8 | 0.8 | 0.8 | 0.8 |
| Defoaming agent | 1.1 | 1.1 | 1.1 | 0.6 | 0.6 | 1.1 | 1.1 | 1.1 | 1.1 |
| Complexing agent 2 | — | — | — | 0.8 | 0.8 | 1.7 | 1.7 | 1.7 | 1.7 |
| Inorganic blend 1 | 64.4 | 55.8 | — | — | — | — | — | 54.1 | 54.1 |
| Inorganic blend 2 | — | — | 64.4 | 27.1 | 27.1 | — | — | — | — |
| Inorganic blend 3 | — | — | — | — | — | 54.1 | 54.1 | — | — |
| pH | 2.0-2.5 | 2.0-2.5 | 2.0-2.5 | 2.0-2.5 | 2.0-2.5 | 2.0-2.5 | 2.0-2.5 | 2.0-2.5 | 2.0-2.5 |

| | | | | | | | |
|---|---|---|---|---|---|---|---|
| Application liquid | inhomogen., not applicable | homogen. | homogen. | homogen. | homogen. | homogen. | homogen. |

| HDG substrate | VB39 | VB40 | VB41 | B42 | B43 | B44 | B45 | B46 | B47 |
|---|---|---|---|---|---|---|---|---|---|
| Ti support, mg/m² | — | — | — | 10 | 10 | — | — | 20 | 20 |
| Zr support, mg/m² | — | — | — | — | — | 20 | 20 | — | — |
| Dry film support, mg/m² | — | — | — | 520 | 520 | 1040 | 1040 | 1040 | 1040 |
| Dry substance:Ti ratio | — | — | — | 52 | 52 | — | — | 52 | 52 |
| Dry substance:Zr ratio | — | — | — | — | — | 52 | 52 | — | — |
| ZE substrate | VB39 | VB40 | VB41 | B42 | B43 | B44 | B45 | B46 | B47 |
| Ti support, mg/m² | — | — | — | 12 | 12 | — | — | 20 | 20 |
| Zr support, mg/m² | — | — | — | — | — | 20 | 20 | — | — |
| Dry film support, mg/m² | — | — | — | 624 | 624 | 1040 | 1040 | 1040 | 1040 |
| Dry substance:Ti ratio | — | — | — | 52 | 52 | — | — | 52 | 52 |
| Dry substance: Zr ratio | — | — | — | — | — | 52 | 52 | — | — |

| Dry film properties | VB39 | VB40 | VB41 | B42 | B43 | B44 | B45 | B46 | B47 |
|---|---|---|---|---|---|---|---|---|---|
| Substrate | HDG | HDG | HDG | HDG | HDG | HDG | HDG | HDG | HDG |

Corrosion in the salt spray test:

| | | | | | | | | | |
|---|---|---|---|---|---|---|---|---|---|
| % surface corrosion after 48 h | — | — | — | 30 | 0 | 0 | 0 | 5 | 0 |
| % surface corrosion after 96 h | — | — | — | 60 | 0 | 5 | 0 | 30 | 0 |
| % surface corrosion after 168 h | — | — | — | — | — | 20 | 0 | 80 | 0 |

Resistance to cleaner, 65° C., 120 s:

| | | | | | | | | | |
|---|---|---|---|---|---|---|---|---|---|
| % by weight dry film removal | — | — | — | — | — | 20 | 10 | 10 | 0 |
| Substrate | ZE | ZE | ZE | ZE | ZE | ZE | ZE | ZE | ZE |

Corrosion in the salt spray test:

| | | | | | | | | | |
|---|---|---|---|---|---|---|---|---|---|
| % surface corrosion after 48 h | — | — | — | 90 | 20 | 5 | 0 | 5 | 0 |
| % surface corrosion after 72 h | — | — | — | 100 | 100 | 20 | 2 | 20 | 2 |
| % surface corrosion after 120 h | — | — | — | — | — | 60 | 30 | 60 | 30 |

The compositions according to the invention have proven to be very suitable as acidic preparations, with pH values in particular in the range of 1.5 to 3, for coating substrates made of pure zinc, zinc-titanium alloys, hot dip-galvanized steel, and electrolytically galvanized steel.

If no complexing agent 2 or insufficient overall complexing agent has been added, precipitation and inhomogeneities could easily result in these acidic compositions, and therefore no suitable film could be applied (VB39-VB41).

Due to the pickling effect, during the application and drying a chemical reaction takes place between the treatment liquid and the substrate surface. Optimal corrosion protection properties are thus achieved while maintaining the optimal substrate appearance.

A ratio of polymer/copolymer e)+wax f) to inorganic fractions a) through d) approximately in the range of (2 to 2.5):1 has proven to be optimal for most properties of the coatings according to the invention.

It turned out that a certain content of Ti and/or Zr is necessary in all the tests. This is because of the possible need to provide a thin layer based on Ti and/or Zr on the metallic substrate. It has been shown to be important that the Ti and/or Zr support, calculated as metal, is in a range between 15 and 50 mg/m² or between 20 and 40 mg/m², determined by X-ray fluorescence analysis. The corrosion protection may be impaired if the support is smaller, if the support is larger, the pickling attack is often too great, or the consumption of chemicals is often unnecessarily high.

It has been proven to be advantageous, and sometimes even necessary, for the composition according to the invention to have a pickling effect on the metallic surface. This is because if the pickling effect due to the composition is too low, the corrosion protection is often inadequate, if the pickling effect due to the composition is too great, an excessive quantity of cations of the metallic surface is absorbed by the aqueous composition and the coating to be produced, whereby the latter may have lower corrosion protection.

It has been shown in some cases that the composition according to the invention is more stable and durable the lower its pH. However, when a particularly stable composition is prepared, it must be ensured that the pickling effect of the composition is not too great, so that buffering, if applicable, with ammonia and/or an amine, for example, occurs.

While the inorganic portion of the composition (“inorganic” fraction, including additives thereof) is important to provide a pickling effect and a possibly oxidic first thin layer based on Ti and/or Zr on the metallic substrate, the organic portion of the composition (“organic” fraction, including lubricant and other additives) is important to provide a closed, corrosion-resistant coating with sliding capability.

In many embodiment variants, the addition of a film-forming agent is helpful for satisfactory, homogeneous formation of the coating. The film-forming agent is added in particular for hard resins in order to temporarily soften same.

Adding at least one silane/silanol/siloxane has not proven to be necessary for either the inorganic or the organic fraction, but is helpful in some compositions. Such an addition may be advantageous in particular when aluminum-rich surfaces are coated.

Adding at least one corrosion inhibitor such as molybdate may ensure additional corrosion protection.

High moisture resistance of the dry films was achieved for all the samples according to the invention when, after application, only a few hours were expected to elapse until the dry films were used or until the moisture resistance test was conducted. In that case, the moisture resistance resulted due to a further secondary reaction after heating and/or drying.

For good antifingerprint behavior of the coating according to the invention, a layer weight of at least 1000 mg/m² or even at least 1200 mg/m² is often necessary, and frequently a higher proportion of polymer/copolymer is required. In particular, an increased content of acid-tolerant cationic polyurethane has proven to be helpful for good antifingerprint behavior and good overcoatability of the coating according to the invention.

In comparison to the coatings according to the invention on EZ and HDG [substrates]; on zinc-aluminum alloys such as Galvalume® and Gallon®, for example, all necessary properties were achieved with the exception of a satisfactory esthetic appearance of the grain structure, since these alloys acquired a gray coloration in the absence of subsequent lacquering.

1.-21. (canceled)

22. A method for coating a metallic surface comprising the steps of:
applying to a metallic surface an aqueous composition having a pH in the range of 1 to 4, wherein the aqueous composition comprises:
at least 1 g/L phosphate, calculated as PO₄,
b) at least 0.1 g/L of at least one member selected from the group consisting of a titanium compound and a zirconium compound, calculated as Ti metal,
c) at least 0.1 g/L of at least one complexing agent,
d) at least 0.5 g/L of a member selected from the group consisting of an aluminum cation, a chromium(III) cation, a zinc cation, an aluminum compound, a chromium(III) compound and a zinc compound; and
e) 1 to 500 g/L of a cationic polyurethane-rich dispersion, having a content of polycarbonate and/or an acid-tolerant dispersion based on acrylate and/or styrene which is/are present in stable form in the aqueous composition, or of at least one dispersion of acid-tolerant cationic or nonionic organic polymer/copolymer composed of acid-tolerant cationic copolymer based on cationic polyurethane and/or based on polyester-polyurethane, polyester-polyurethane-poly(meth)acrylate, polycarbonate-polyurethane, or polycarbonate-polyurethane-poly(meth)acrylate, relative to the content of solids and active substances in the additives to organic polymer/copolymer,
in which no precipitation occurs in the aqueous composition over a period of at least 4 weeks; and
allowing the coating to form a film on said metallic surface after application of said aqueous composition to said metallic surface to yield a coated metallic component.

23. A method according to claim 22, wherein the organic polymer/copolymer e) has a minimum film formation temperature MFT in the range of −20 to +100° C., or the film thus formed has a transformation temperature Tg in the range of −1.0 to +120° C. and/or a König pendulum hardness in the range of 10 to 140 s.

24. A method according to claim 22, Wherein the organic polymer/copolymer e) has a content of poly(meth)acrylate, polycarbonate, polyester, polyether, polyethylene, polystyrene, polyurethane, polyvinyl, and/or modification(s) thereof.

25. A method according to claim 22, wherein the composition has a weight ratio of organic polymers/copolymers e) to the inorganic passivating agent based on a) through d) in the range of 8:1 to 0.2:1 or 6:1 to 0.8:1.

26. A method according to claim 22, wherein the composition has an overall content of cations of aluminum, chromium(III), and/or zinc, and/or at least one compound having a content of aluminum, chromium(I), and/or zinc, in the range of 0.5 to 80 g/L, calculated as metal.

27. A method according to claim 22, wherein the composition has an overall content of cations of iron and/or manganese, and/or at least one compound having a content of iron and/or manganese, in the range of 0.1 to 20 g/L, calculated as metal.

28. A method according to claim 22, Wherein the composition has a content of phosphate in the range of 1 to 250 g/L, calculated as PO₄.

29. A method according to claim 22, wherein the composition has an overall content of at least one complexing agent in the range of 0.1 to 60 g/L.

30. A method according to claim 22, Wherein the composition has an overall content of at least one titanium and/or zirconium compound, based on complex fluoride, in the range of 1 to 200 g/L, calculated as the respective compound.

31. A method according to claim 22, wherein the composition has a free fluoride content F_{free} in the range of 0.01 to 5 g/L and/or a total fluoride content Fₜₒₜₐₗ in the range of 0.5 to 80 g/L.

32. A method according to claim 22, wherein the composition has a content of at least one silane/silanol/siloxane/polysiloxane in the range of 0.1 to 50 g/L, calculated based on Si metal.

33. A method according to claim 22, wherein the composition contains at least one inorganic compound in particle form based on Al₂O₃, SiO₂, TiO₂, ZnO, ZrO₂, carbon black, and/or corrosion protection particles, which have an average particle diameter less than 300 nm as measured by a scanning electron microscope.

34. A method according to claim 22, wherein a metallic surface based on aluminum, iron, magnesium, titanium, zinc, and/or tin is treated with the aqueous composition.

35. An aqueous composition, wherein the aqueous composition comprises:
a) at least 1 g/L phosphate, calculated as PO₄,
b) at least 0.1 g/L of at least one member selected from the group consisting of a titanium compound and a zirconium compound, calculated as Ti metal,
c) at least 0.1 g/L of at least one complexing agent,
d) at least 0.5 of at least cation of aluminum, chromium(III), or zinc, or at least one compound containing aluminum, chromium(III), or zinc, and
c) 1 to 500 g/L, of a cationic polyurethane-rich dispersion, having a content of polycarbonate and/or an acid-tolerant dispersion based on acrylate and/or styrene which is/are present in stable form in the aqueous composition, or of at least one dispersion of acid-tolerant cationic or nonionic organic polymer/copolymer composed of acid-tolerant cationic copolymer based on cationic polyurethane and/or based on polyester-polyurethane, polyester-polyurethane-poly(meth)acrylate, polycarbonate-polyurethane, or polycarbonate-polyurethane-poly(meth)acrylate, relative to the content of solids and active substances in the additives to organic polymer/copolymer, in which no precipitation occurs over a period of at least 4 weeks.

36. The film on said metallic surface produced according to the method of claim 22.

37. A metallic component prepared by the method according to claim 22.
